(19) United States
(12) Patent Application Publication
(10) Pub. No.: US 2025/0020919 A1
(43) Pub. Date: Jan. 16, 2025

(54) IMAGE ARTIFACT MITIGATION IN A DISPLAY SYSTEM HAVING A FOLDED OPTICAL PATH

(71) Applicant: Intuitive Surgical Operations, Inc., Sunnyvale, CA (US)

(72) Inventors: Adam P. Samaniego, San Carlos, CA (US); Randal P. Goldberg, San Mateo, CA (US); Ian E. McDowall, Woodside, CA (US)

(21) Appl. No.: 18/712,072

(22) PCT Filed: Dec. 15, 2022
(86) PCT No.: PCT/US2022/053041

§ 371 Date: May 21, 2024

Related U.S. Application Data
(60) Provisional application No. 63/290,526, filed on Dec. 16, 2021.

(51) Int. Cl. G02B 27/01

(52) U.S. Cl. CPC G02B 27/0101; G02B 27/0103; G02B 2027/0109; G02B 2027/011; G02B 2027/0118

(57) ABSTRACT

A display system includes a display panel, a first reflector, and a second reflector. The display panel provides first image light representative of a displayed image to the first reflector and provides second image light representative of at least a portion of the displayed image to the second reflector without first being reflected by the first reflector. The first reflector reflects the first image light toward the second reflector. The second reflector reflects the first image light toward an eyepiece. The second reflector is positioned relative to the second image light and a polarization direction of the second image light incident on the second reflector has a first orientation such that reflectance of a portion of the second image light from the second reflector is approximately zero. A light control device behind the display panel may control a distribution angle of image light from the display panel.

### RELATED APPLICATIONS

The present application claims priority to U.S. Provisional Patent Application No. 63/290,526, filed Dec. 16, 2021, the contents of which is hereby incorporated by reference in its entirety.

### BACKGROUND INFORMATION

During a computer-assisted surgical procedure, a surgeon may manipulate user input devices to control teleoperated surgical instruments to perform a minimally-invasive surgical procedure on a subject. An imaging device (e.g., an endoscope) may capture images of a surgical area, and a surgical display system may present the captured images to the surgeon to provide a visualization of the surgical area. The surgeon may view the images of the surgical area through an eyepiece while performing the surgical procedure.

In the surgical display system, a display panel (e.g., an LCD panel) may be positioned to the side of or above the user eyepiece so that the user input devices may be positioned in front of the user. The displayed images are viewable through the eyepiece by folding the optical path of the image light. For example, a first mirror may reflect image light from the display panel to a second mirror, and the second mirror may reflect the image light from the first mirror toward the eyepiece. However, folding the optical path may produce undesired image artifacts when image light from the display panel is viewable through the eyepiece by other than the intended optical path.

### SUMMARY

The following description presents a simplified summary of one or more aspects of the systems and methods described herein. This summary is not an extensive overview of all contemplated aspects and is intended to neither identify key or critical elements of all aspects nor delineate the scope of any or all aspects. Its sole purpose is to present one or more aspects of the systems and methods described herein as a prelude to the detailed description that is presented below.

An illustrative display system comprises a display panel; a first reflector; and a second reflector; wherein: the display panel provides first image light representative of a displayed image to the first reflector and provides second image light representative of at least a portion of the displayed image to the second reflector without first being reflected by the first reflector; the first reflector reflects the first image light from the display panel toward the second reflector; the second reflector reflects the first image light from the first reflector toward an eyepiece; and the second reflector is positioned relative to the second image light and a polarization direction of the second image light incident on the second reflector has a first orientation such that reflectance of a portion of the second image light from the second reflector is approximately zero.

An illustrative display system comprises a display panel configured to modulate source light emitted by a backlight to provide image light representative of a displayed image; and a light control device positioned behind the display panel and configured to control a distribution angle of the image light.

An illustrative display system comprises a display panel that provides first polarized image light representative of a displayed image and second polarized image light representative of a portion of the displayed image; and a reflector positioned to reflect the first polarized image light and such that reflectance of a portion of the second polarized image light is approximately zero.

An illustrative light control device comprises a light control film configured to control a distribution angle of source light emitted by a backlight; and a lens configured to redirect source light transmitted through the light control film toward an observation point.

An illustrative light control device comprises a holographic element having a recorded interference pattern produced by a reference beam and an object beam incident on a light emission side of a display panel and transmitted through the display panel.

An illustrative method of making a light control device comprises recording, by a holographic element, an interference pattern produced by interference of: a reference beam incident on the holographic element; and an object beam incident on the holographic element after the object beam was incident on a light-emission side of a display panel and transmitted through the display panel.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements. Furthermore, the figures are not necessarily drawn to scale as one or more elements shown in the figures may be enlarged or resized to facilitate recognition and discussion.

FIGS. 1 and 2 show views of an illustrative configuration of a display system having a folded optical path.

FIG. 3 shows an illustrative display system having a folded optical path that uses the Brewster effect to mitigate image artifacts caused by stray image light.

FIG. 4A shows a configuration of a second reflector of the display system of FIG. 3 relative to a ray of the second image light incident on the second reflector.

FIG. 4B shows a configuration of the second reflector of the display system of FIG. 3 relative to an incident ray and a reflected ray of first image light.

FIG. 5 shows a graph of the optical properties of polycrystalline silicon that may be used for the second reflector of the display system of FIG. 3.

FIG. 6 shows the display system of FIG. 3 configured so that the polarization direction of the second image light has a first orientation.

FIG. 7 shows an illustrative configuration of the display system of FIG. 3 including a polarization rotator.

FIG. 8 shows another display system having a folded optical path that includes a light control device configured to control the distribution angle of image light to mitigate image artifacts caused by stray image light.

FIG. 9 shows an illustrative functional configuration of a backlight and a display panel of the display system of FIG. 8 in operation with a light control film that implements the light control device of FIG. 8.

FIGS. 10A and 10B show illustrative implementations of the light control film of FIG. 9.

FIG. 11 shows another illustrative functional configuration of the backlight and display panel of FIG. 8 in operation with a light control device that includes a light control film and a Fresnel lens.

FIG. 12 shows an illustrative configuration of a backlight and a display panel in operation with a curved light control device.

FIG. 13 shows an illustrative configuration of a backlight and a display panel in operation with a planar light control device that functions similarly to a curved light control device.

FIG. 14 shows an illustrative configuration of a recording stage for recording a holographic element to be used as a light control device.

FIG. 15 shows an illustrative configuration of a playback stage of the holographic element of FIG. 14.

FIG. 16 shows an illustrative configuration of an integrated backlight/light control device that produces backlight for a display panel.

FIG. 17 shows another illustrative configuration of the integrated backlight of FIG. 16.

FIG. 18 shows an illustrative computer-assisted surgical system.

FIG. 19 shows an illustrative user control system with which a user may interact to control various operations of the computer-assisted surgical system of FIG. 18.

### DETAILED DESCRIPTION

Apparatuses, systems, and methods for mitigation of image artifacts in a surgical display system having a folded optical path are described herein. For example, in some implementations a display system includes a display panel, a first reflector, and a second reflector. The display panel provides first image light representative of a displayed image to the first reflector and provides second image light representative of at least a portion of the displayed image to the second reflector without first being reflected by the first reflector. The first reflector reflects the first image light from the display panel toward the second reflector. The second reflector reflects the first image light from the first reflector toward an eyepiece. The second reflector is positioned relative to the second image light and a polarization direction of the second image light incident on the second reflector has a first orientation such that reflectance of a portion of the second image light from the second reflector is approximately zero. In this implementation, image artifacts generated by the second image light are mitigated by positioning the second reflector relative to the second image light such that rays of the second image light are incident on the second mirror at or near the Brewster angle of the second reflector, and by orienting the polarization direction of the second image light such that no reflection can occur for light incident at the Brewster angle. Thus, reflectance of a portion of the second image light from the second reflector is approximately zero. In some examples, the second reflector comprises a silicon block or plate (e.g., a silicon mirror).

In additional or alternative implementations, a display system includes a display panel and a light control device. The display panel is configured to modulate source light emitted by a backlight to provide image light representative of a displayed image. The light control device is positioned behind the display panel and is configured to control a distribution angle of the image light. In these implementations, image artifacts that would otherwise be caused by the wide distribution angle of image light are mitigated by positioning the light control device behind the display panel, which reduces the distribution angle of the image light so that the artifact-producing stray image light is not viewable through the eyepiece. Controlling the distribution angle of the source light emitted from the backlight may also reduce stray light in the system, thereby improving image contrast and reducing wall brightness.

Various embodiments of the apparatuses and systems will be described in detail with reference to the figures. It will be understood that the embodiments described below are provided as non-limiting examples of how various novel and inventive principles may be applied in various situations. Additionally, it will be understood that other examples not explicitly described herein may also be captured by the scope of the claims set forth below. Apparatuses and systems described herein may provide one or 20 more benefits that will be explicitly described or made apparent below.

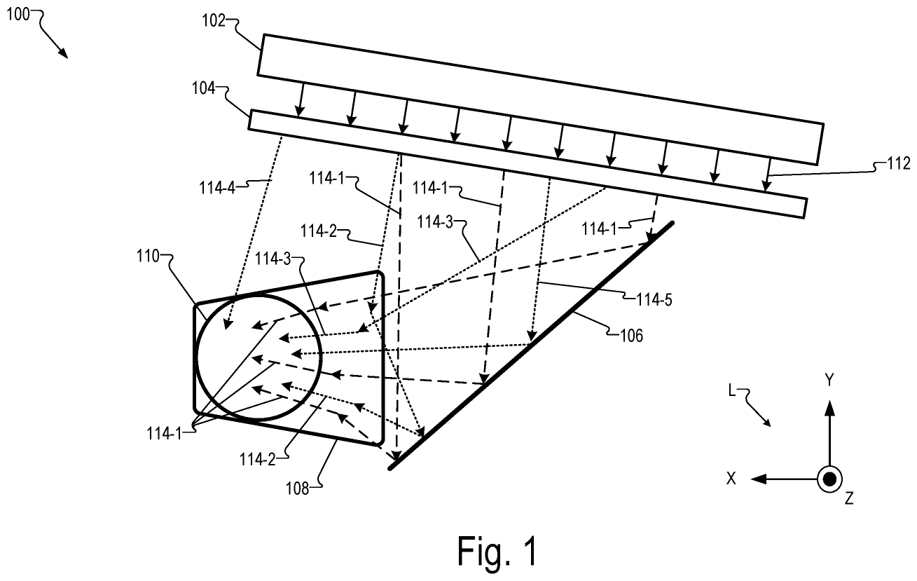

FIGS. 1 and 2 show an illustrative configuration of a display system 100 having a folded optical path. As shown, display system 100 includes a backlight 102 (shown only in FIG. 1), a display panel 104, a first reflector 106, a second reflector 108, and an eyepiece 110. Display system 100 may include additional or alternative 25 components as may suit a particular implementation, such as one or more optical components (e.g., lenses, filters, mirrors, light guides, diffractive elements, attenuators, etc.), an infrared light source, an infrared photodetector, baffles, support members, and the like. In some examples, display system 100 shown in FIGS. 1 and 2 implements only a right eye component of an image display system (e.g., a stereoscopic display system). A left eye component of an image display system may be implemented in a similar manner to display system 100, and thus discussion of the left eye component is omitted.

FIGS. 1 and 2 show a legend L that has been arbitrarily oriented so that an optical axis of eyepiece 110 and/or an optical axis of image light reflected by second 35 reflector 108 extends in the Z direction. FIG. 1 shows a view of display system 100 from the +Z direction and FIG. 2 shows a view of display system 100 from the +Y direction.

As shown in FIG. 1, backlight 102 is configured to emit source light 112 (indicated as solid-line arrows) to display panel 104. Backlight 102 includes a light source, such as a light-emitting diode (LED) light source or any other suitable source of light. Backlight 102 may also include other components as may suit a particular implementation, such as a diffuser (e.g., a light guide plate, a reflector, etc.), a polarizing filter, a reflective polarizer, a switching filter. While FIG. 1 shows that backlight 102 is separated from display panel 104 by a gap (e.g., an air gap), backlight 102 may alternatively be provided on (e.g., adjacent to or in contact with) or integrated with display panel 104 (e.g., an LED display panel). Furthermore, while FIG. 1 shows that backlight 102 is directly behind display panel 104, in other implementations backlight 102 may be positioned elsewhere and source light 112 may be guided to display panel 104 by one or more optical components (e.g., lenses, light guides, reflectors, mirrors, etc.)

Display panel 104 is configured to modulate source light 112 based on image data (e.g., image data representative of an image captured by an imaging device) to provide image light 114 representative of a displayed image. Image light 114 includes first image light 114-1 (represented by dashed lines), second image light 114-2 (represented by dotted lines), and third image light 114-3 (also represented by dotted lines). First image light 114-1 is image light that forms a full image represented by the image data and that is viewable by a user through eyepiece 110. Second image light 114-2 and third image light 114-3 are stray image light from display panel 104 that reach second reflector 108 by an alternative optical path, which reflects second image light 114-2 toward eyepiece 110 and create image artifacts that may also be viewable by the user through eyepiece 110. Fourth image light 114-4 is stray image light from display panel 104 that bypasses first reflector 106 and second reflector 108 and reaches eyepiece 110 directly and thus creates image artifacts that may also be viewable by the user through eyepiece 110. Fifth image light 114-5 is stray image light from display panel 104 that reflects from first reflector 106 directly to eyepiece 110 (e.g., bypasses second reflector 108) and thus creates image artifacts that may also be viewable by the user through eyepiece 110. It will be understood that the dashed lines of first image light 114-1 and dotted lines of second image light 114-2, third image light 114-3, fourth image light 114-4, and fifth image light 114-5 shown in FIGS. 1 and 2 are merely representative of the optical paths of some of the many rays of image light 114 provided by display panel 104.

In some examples, eyepiece 110 may be omitted, such as when display system 100 is an “open” display system. In the open display systems, first image light 114-1 is viewable by a user at an observation point (e.g., a location where a user's eye may be positioned to view first image light). For example, an observation point may be a location in front of a monitor, a flat screen, a display screen, etc. Second image light 114-2 and third image light 114-3 may reach the observation point by an alternative optical path, which reflects second image light 114-2 toward the observation point and create image artifacts that may also be viewable by the user from the observation point.

Display panel 104 may be any suitable display device, such as a liquid crystal display (LCD) panel (e.g., an active-matrix LCD panel), a liquid crystal on silicon (LCOS) panel), an LED panel (e.g., an organic LED (OLED) panel, an active-matrix OLED (AMOLED), a quantum dot LED (QLED)), an electroluminescent display panel, a plasma display panel, a digital micromirror display (DMD) panel (e.g., a digital light processing (DLP) panel), and the like. Display panel 104 may be communicatively coupled to an image controller (not shown) configured to drive display panel 104 to modulate source light 112 to provide first image light 114-1. In some implementations, the image data is representative of a surgical scene captured by a surgical imaging device (e.g., an endoscope).

First reflector 106 and second reflector 108 may each be any suitable device configured to reflect first image light 114-1 to thereby fold the optical path of first image light 114-1. For example, first reflector 106 and second reflector 108 may each be a bare aluminum mirror or a silver-coated mirror. In some examples, as will be explained below in more detail, second reflector 108 may be a polished mirror formed of any material that absorbs light in the visible spectrum and that has a suitably high refractive index. For example, second reflector 108 may be a mirror made of a material, such as silicon and/or black glass, configured to absorb second image light 114-2 that is incident on second reflector 108 at about the Brewster angle and reflect first image light 114-1 that is incident on second reflector 108 at an angle other than the Brewster angle.

As shown in FIGS. 1 and 2, first image light 114-1 follows a folded optical path. As shown in FIG. 1, display panel 104 provides first image light 114-1 to first reflector 106, which is angled relative to display panel 104 to reflect first image light 114-1 received from display panel 104 toward second reflector 108. Second reflector 108 is angled relative to first reflector 106 to reflect first image light 114-1 received from first reflector 106 light toward eyepiece 110. Eyepiece 110 may include any optical components (e.g., lenses, collimators, mirrors, etc. (not shown)) and/or structural components (e.g., a lens mount, frames, etc. (not shown)) configured to enable a user to view first image light 114-1 reflected by second reflector 108. For example, second reflector 108 and/or eyepiece 110 may direct first image light 114-1 received from second reflector in the +Z direction.

As shown in FIGS. 1 and 2, display system 100 folds the optical path of image light 114-1 out (e.g., in the −X direction) and up (e.g., in the +Y direction) from eyepiece 110. This folded optical path leaves room behind eyepiece 110 and second reflector 108 (e.g., in the −Z direction) for other physical components. For example, as will be explained below in more detail, user input devices of a computer-assisted surgical system may be positioned behind eyepiece 110 and second reflector 108.

It will be recognized that the configuration of display system 100 shown in FIGS. 1 and 2 is merely illustrative, as the components of display system 100 may be arranged in any other suitable configuration to fold the optical path in any other way. Additionally, while FIGS. 1 and 2 show that display system 100 has two reflectors 106 and 108, display system 100 may include any other number of reflectors (e.g., only one or three or more) to fold the optical path any number of times as may suit a particular implementation.

When the optical path of display system 100 is folded, such as is shown in FIGS. 1 and 2, second image light 114-2, third image light 114-3, and fifth image light 114-5 from display panel 104 reach second reflector 108 by an alternative optical path (e.g., an optical path other than the optical path of first image light 114-1) and thereby create image artifacts that may be viewed through eyepiece 110. For example, first image artifacts may be created by second image light 114-2 from display panel 104, which is incident on second reflector 108 without first being reflected by first reflector 106. Second reflector 108 reflects second image light 114-2 received from display panel 104 toward first reflector 106, which then reflects second image light 114-2 back to second reflector 108. Second reflector 108 reflects second image light 114-2 received from first reflector 106 toward eyepiece 110, thereby creating the first image artifacts that represent at least a portion of the image displayed by display panel 104.

Second image artifacts may be created by third image light 114-3 from display panel 104. Due to the wide distribution angle of third image light 114-3 from display panel 104, third image light 114-3 is incident on second reflector 108 without first being reflected by first reflector 106. Second reflector 108 then reflects third image light 114-3 received from display panel 104 toward eyepiece 110, thereby creating the second image artifacts, which represent another portion of the image displayed by display panel 104.

Third image artifacts may be created by fourth image light 114-4 from display panel 104, and fourth image artifacts may be created by fifth image light 114-5 from display panel 104. Due to the wide distribution angle of fourth image light 114-4 from display panel 104, fourth image light 114-4 is incident on eyepiece 110 directly without first being reflected by first reflector 106 or second reflector 108, thereby creating the third image artifacts, which represent another portion of the image displayed by display panel 104. Due to the wide distribution angle of fifth image light 114-5 from display panel 104, fifth image light 114-5 is reflected directly from first reflector 106 to eyepiece 110, thereby creating the fourth image artifacts, which represent another portion of the image displayed by display panel 104.

The first, second, third, and fourth image artifacts described in FIGS. 1 and 2 are merely examples of image artifacts that may be generated by the folded optical path of display system 100. It will be understood that other image artifacts may be generated by display system 100, and other configurations and arrangements of display system 100 may result in additional and/or alternative image artifacts not shown or described with reference to FIGS. 1 and 2. While FIGS. 1 and 2 show that the first, second, third, and fourth image artifacts are located within the displayed image, the first, second, third, and fourth image artifacts may alternatively appear within a peripheral region outside of the displayed image.

Illustrative display systems that mitigate or eliminate image artifacts caused by image light that follows an alternative optical path (e.g., second image light 114-2, third image light 114-3, fourth image light 114-4, and/or fifth image light 114-5) will now be described.

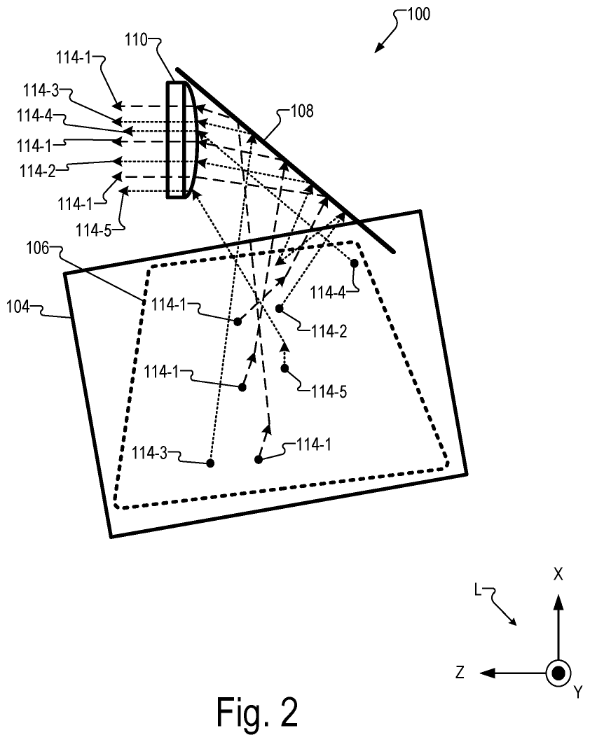

FIG. 3 shows an illustrative display system 300 having a folded optical path that uses the Brewster effect to mitigate the first image artifacts caused by second image light 114-2. The Brewster effect is an optical phenomenon in which, when linearly polarized light is incident on a refractive surface at a specific angle of incidence (the Brewster angle), only s-polarized light is reflected while other polarized light (e.g., p-polarized light) is refracted. The Brewster angle is the angle of incidence (the angle between the incident light and a vector normal to the incident surface) at which the angle between reflected light and refracted light is 90°. Since the angle of refraction depends on the refractive index of the incident material, the Brewster angle depends on the refractive index of the incident material.

Display system 300 is similar to display system 100 except that, in display system 300, the position of second reflector 108 and the polarization of second image light 114-2 are configured so that reflectance of at least a portion second of image light 114-2 from second reflector 108 is approximately zero due to the Brewster effect.

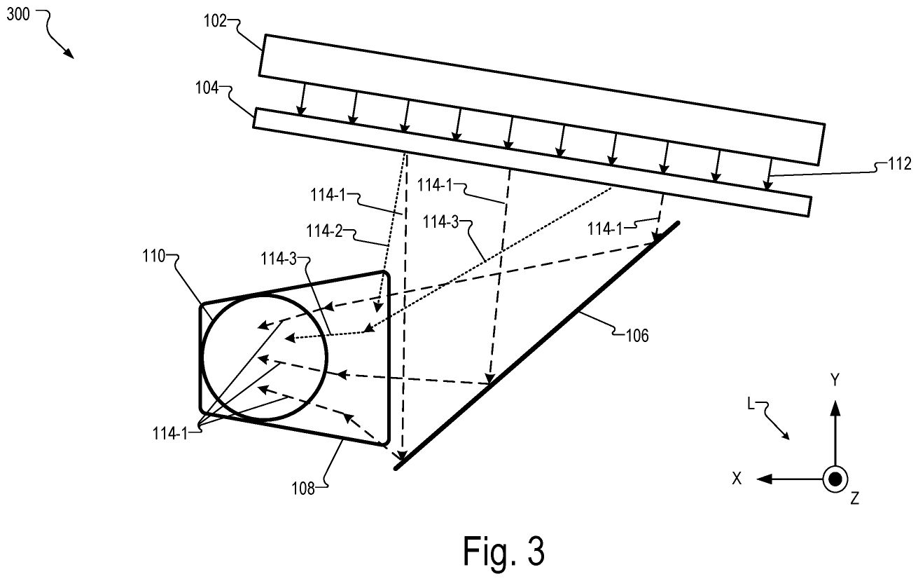

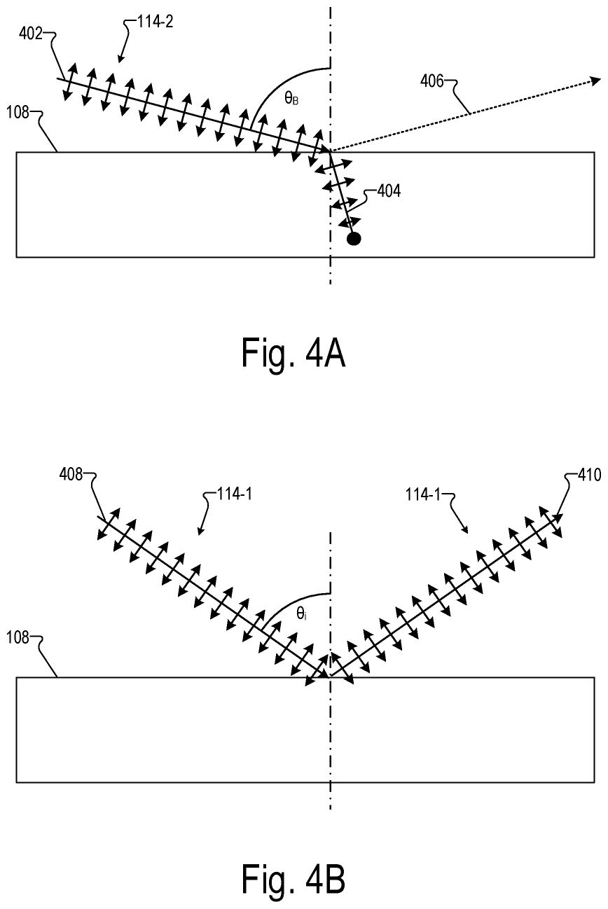

FIG. 4A shows a configuration of second reflector 108 relative to a ray 402 of second image light 114-2 incident on second reflector 108. It will be recognized that second image light 114-2 incident on second reflector 108 is generally not a single ray as shown in FIG. 4A but is a cone of multiple rays. Ray 402 of second image light 114-2 shown in FIG. 4A represents a portion (e.g., a subset of rays) of second image light 114-2, an average angle of a portion (e.g., a subset of rays) of second image light 114-2 incident on second reflector 108, or an average angle of all rays of second image light 114-2 incident on second reflector 108.

As shown, second reflector 108 is positioned relative to second image light 114-2 (e.g., ray 402) so that at least a portion of second image light 114-2 received directly from display panel 104 is incident on second reflector 108 at approximately the Brewster angle θ_{B} of second reflector 108. When second image light 114-2 is p-polarized with respect to second reflector 108, second image light 114-2 is refracted within second reflector 108, as indicated by ray 404, and is not reflected from second reflector 108 in the direction of dotted ray 406 (a reflection direction of s-polarized light).

On the other hand, second reflector 108 is positioned relative to first image light 114-1 so that first image light 114-1 received from first reflector 106 is incident on second reflector 108 at an angle of incidence θᵢ other than the Brewster angle θ_{B} of second reflector 108. FIG. 4B shows a configuration of second reflector 108 relative to incident ray 408 and reflected ray 410 of first image light 114-1. Rays 408 and 410 are representative of the many rays of image light 114-1 that may be incident on and reflected from second reflector 108. As shown, first image light 114-1 is incident on second reflector 108 at an angle of incidence θᵢ at which first image light 114-1 is reflected toward eyepiece 110, as represented by reflected ray 410. It will be recognized that angle of incidence θᵢ may be a range of suitable angles at which different rays of first image light 114-1 may be incident on second reflector 108.

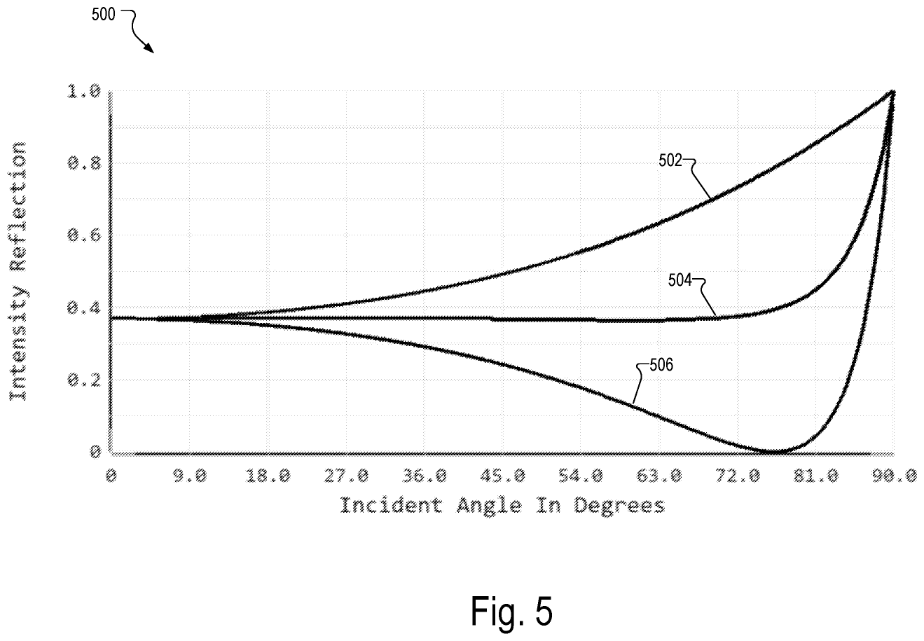

Second reflector 108 may be formed of any suitable material configured to reflect first image light 114-1 having an angle of incidence θᵢ other than the Brewster angle and transmit and/or absorb p-polarized second image light 114-2 that is incident at the Brewster angle θ_{B}. In some examples, second reflector 108 is a silicon mirror (e.g., formed of polycrystalline silicon) or a black glass mirror, each of which absorbs non-reflected visible light. FIG. 5 shows a graph 500 of the optical properties of polycrystalline silicon. Graph 500 plots intensity of reflection from a polycrystalline silicon material as a function of the incident angle for three different types of light. A first curve 502 represents reflection of s-polarized light, a second curve 504 represents reflection of average polarized light, and a third curve 506 represents reflection of p-polarized light. As can be seen, the intensity of reflection of s-polarized light is greater than about 40% for all angles of incidence. In contrast, the intensity of reflection of p-polarized light is zero at an angle of incidence of approximately 76° (the Brewster angle of polycrystalline silicon). The intensity of reflection of p-polarized light rises sharply at angles of incidence of about 81° or more.

First image light 114-1 and second image light 114-2 may have any suitable angle of incidence on second reflector 108 configured to mitigate or eliminate artifacts created by second image light 114-2 while also reflecting first image light 114-1 from first reflector 106 toward eyepiece 110 to thereby make the displayed image viewable through eyepiece 110. The angle of incidence of first image light 114-1 or second image light 114-2 refers to the angle of incidence on second reflector 108 of each ray included in all or a portion (e.g., a subset of rays) of first image light 114-1 or second image light 114-2, an average angle of incidence of a portion (e.g., a subset of rays) of first image light 114-1 or second image light 114-2 on second reflector 108, an average angle of incidence of all rays of first image light 114-1 or second image light 114-2 incident on second reflector 108, or any other measure of the angle(s) of incidence of one or more rays of first image light 114-1 or second image light 114-2. For example, the angle of incidence of second image light 114-2 on second reflector 108 may be any combination of angles of incidence of rays of second image light 114-2 that optimize (e.g., minimize) the apparent brightness of the second artifact. Additionally or alternatively, the angles of incidence of first image light 114-1 and second image light 114-2 on second reflector 108 may be any combination of angles of incidence of rays of first image light 114-1 and second image light 114-2 that optimize (e.g., maximize) the ratio of the apparent brightness of the desired light (e.g., first image light 114-1) to the undesired light (e.g. second image light 114-2). As used herein, “optimize” means to seek an improved or optimum solution among a set of possible solutions, although the best solution may not necessarily be obtained, such as when an optimization process is terminated prior to finding the best solution, when multiple solutions exist that satisfy predefined criteria, when a solution satisfies minimum criteria, or when a selected optimization technique is unable to converge on the best solution.

In some examples in which second reflector 108 is a silicon mirror formed of polycrystalline silicon, second reflector 108 is positioned relative to second image light 114-2 such that the angle of incidence of second image light 114-2 on second reflector 108 ranges from about 63° to about 83°. In further examples, the angle of incidence of second image light 114-2 on second reflector 108 ranges from about 72° to about 80°. In yet further examples, the angle of incidence of second image light 114-2 on second reflector 108 ranges from about 75° to about 78°. In some examples, the angle of incidence of first image light 114-1 from first reflector 106 on second reflector 108 is greater than about 86°.

It will be recognized that the angles of incidence of first image light 114-1 and second image light 114-2 may have any other suitable values based on the material used for second reflector 108. In some examples, second reflector 108 is positioned relative to second image light 114-2 such that a maximum reflectance of second image light 114-2 reflected from second reflector 108 is less than about 20%. In further examples, the maximum reflectance of second image light 114-2 reflected from second reflector 108 is less than about 10%. In yet further examples, the maximum reflectance of second image light 114-2 reflected from second reflector 108 is less than about 5%. In further examples, second reflector 108 is positioned relative to first image light 114-1 received from first reflector 106 such that a minimum reflectance of first image light 114-1 reflected from second reflector 108 is greater than about 40%.

As mentioned, the polarization of second image light 114-2 is configured so that reflectance of at least a portion second of image light 114-2 (e.g., some of the rays forming second image light 114-2) from second reflector 108 is approximately zero. Referring again to FIG. 4A, second image light 114-2 has a first orientation in which the electric field vector of second image light 114-2 oscillates parallel to the plane of incidence (e.g., is p-polarized light), which plane of incidence is defined by the propagation vector of ray 402 and the vector normal to the surface of second reflector 108.

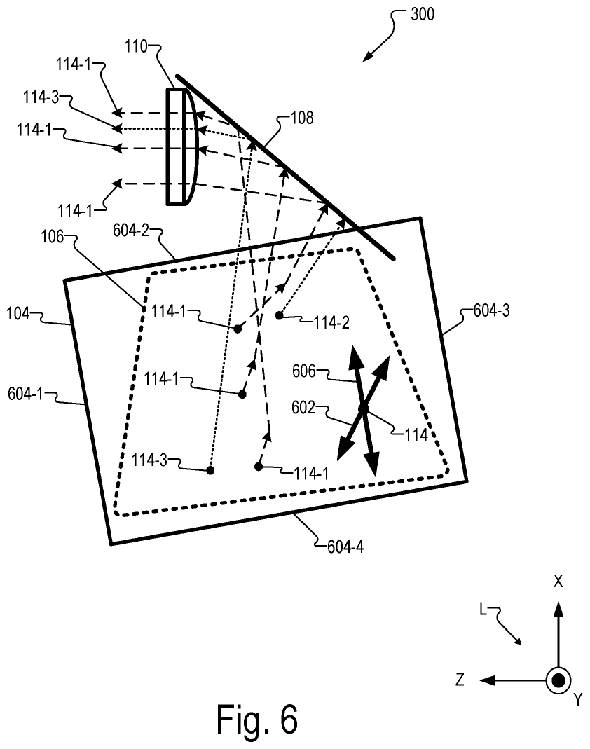

FIG. 6 shows display system 300 configured so that the polarization direction of second image light 114-2 has the first orientation. FIG. 6 is similar to FIG. 2 except that, as explained above, display system 300 uses the Brewster effect to mitigate the first image artifacts caused by second image light 114-2. To this end, image light 114 from display panel 104 is linearly polarized, and a polarization direction of image light 114 has a first orientation indicated by arrow 602. In the example of FIG. 6, image light 114 propagates from display panel 104 and the first orientation is inclined relative to the X-axis and the Z-axis so that the electric field vector of image light 114 oscillates in a plane inclined relative to the X-axis and the Z-axis. When the polarization direction of image light 114 has the first orientation, second image light 114-2 that is incident directly on second reflector 108 without first being reflected by first reflector 106 is p-polarized with respect to second reflector 108. It will be recognized that the first orientation is not limited to the orientation indicated by arrow 602 shown in FIG. 6 but may have any other orientation based on the configuration and arrangement of components of display system 300. Furthermore, the first orientation may additionally or alternatively be inclined relative to an edge 604 (e.g., side edge 604-1, top edge 604-2, side edge 604-3, or bottom edge 604-4) of display panel 104 so that the electric field vector of image light 114 oscillates in a plane inclined relative to an edge 604.

In some examples, the polarization properties of backlight 102 and/or display panel 104 are configured so that the polarization direction of image light 114 has the first orientation. For example, display panel 104 (e.g., an LCD panel) may include one or more polarizing filters configured to linearly polarize image light 114 and/or orient the polarization direction of image light 114 with the first orientation. Additionally or alternatively, backlight 102 may include one or more polarizing filters and/or polarizing rotators configured to linearly polarize source light 112 and/or orient the polarization direction of source light 112 in the first orientation.

In other examples, the polarization properties of backlight 102 and/or display panel 104 are such that the polarization direction of second image light 114-2 does not have the first orientation. For instance, as shown in FIG. 6, the polarization direction of image light 114 may have a second orientation as indicated by arrow 606. In the example of FIG. 6, the second orientation (e.g., a vertical orientation relative to the displayed image) is parallel to side edges 604-1 and 604-3 of display panel 104 so that the electric field vector of image light 114 oscillates in a vertical plane parallel to side edges 604-1 and 604-3. It will be recognized that the second orientation is not limited to the orientation indicated by arrow 606 shown in FIG. 6 but may have any other orientation based on the configuration and arrangement of components of display system 300 (e.g., a horizontal orientation such that the electric field vector of image light 114 oscillates in a plane parallel to top edge 604-2 and bottom edge 604-4). Second image light 114-2 having a polarization direction oriented in the second direction may not be p-polarized with respect to second reflector 108 and thus would be reflected from second reflector 108. Accordingly, the polarization direction of image light 114 from display panel 104 may be rotated so that the polarization direction of image light 114 has the first orientation indicated by arrow 602.

The polarization direction of image light 114 may be rotated from the second orientation to the first orientation in any suitable way. In some examples, display system 300 may include one or more polarization rotators that rotate (in one or more stages) the polarization direction of image light 114 from the second orientation indicated by arrow 606 to the first orientation indicated by arrow 602. A polarization rotator may be implemented by any suitable device or optical film configured to rotate a polarization direction of linearly polarized light, such as a Faraday rotator, a birefringent rotator (e.g., a half-wave plate, a quarter-wave plate, a switchable wave plate, etc.), an absorptive linear polarizer oriented with an appropriate pass-axis direction, or a prism rotator. The polarization rotator may be positioned in any suitable location.

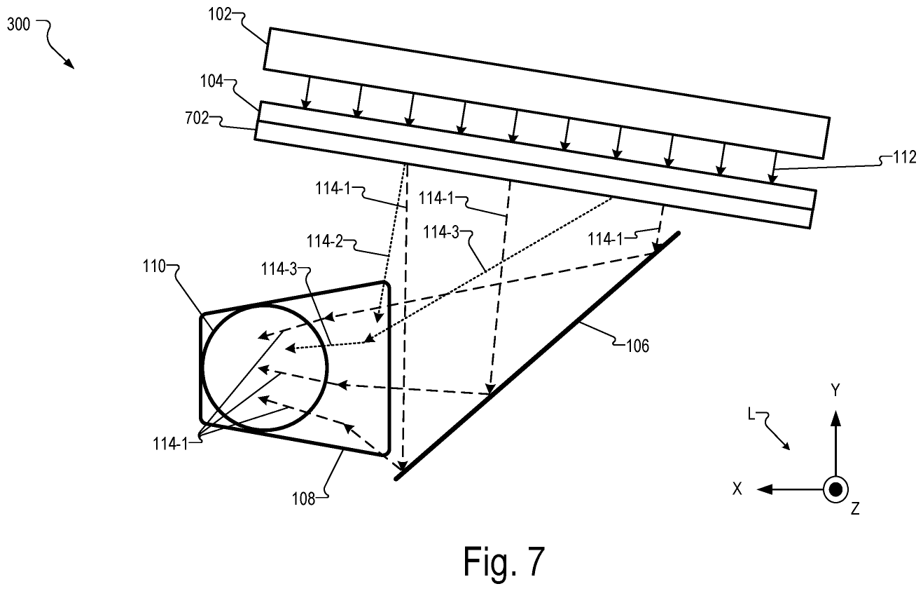

FIG. 7 shows an illustrative configuration of display system 300 including a polarization rotator 702. As shown, polarization rotator 702 is positioned downstream (image light 114 emission side) of display panel 104. While FIG. 7 shows that polarization rotator 702 is provided on display panel 104, in other embodiments polarization rotator 702 may be separated from display panel 104, such as by other optics (e.g., a lens) or by a gap. In additional or alternative examples (not shown), a polarization rotator may be positioned on an upstream side (source light 112 side) of display panel 104. As shown in FIG. 7, polarization rotator 702 covers substantially all of display panel 104 and/or rotates a polarization direction of substantially all image light 114. In alternative examples, polarization rotator 702 covers only a portion of display panel 104 and/or rotates only a polarization direction of second image light 114-2.

In some examples, image light 114 from display panel 104 is not linearly polarized. Accordingly, display system 300 may include a polarizer (not shown) that linearly polarizes second image light 114-2 (or all image light 114) prior to second image light 114-2 reaching second reflector 108. A polarizer and/or a polarization rotator may be positioned at any suitable location, such as on display panel 104, between display panel 104 and first reflector 106, between display panel 104 and second reflector 108, and/or between first reflector 106 and second reflector 108.

With the configuration of display system 300 described above, the first image artifacts caused by second image light 114-2 are substantially mitigated because the linearly polarized second image light 114-2 having a polarization direction in the first orientation is incident on second reflector 108 at or near the Brewster angle. Accordingly, as shown in FIGS. 3, 4, 6, and 7, most of second image light 114-2 is absorbed or transmitted into or through second reflector 108 and thus is not reflected toward eyepiece 110.

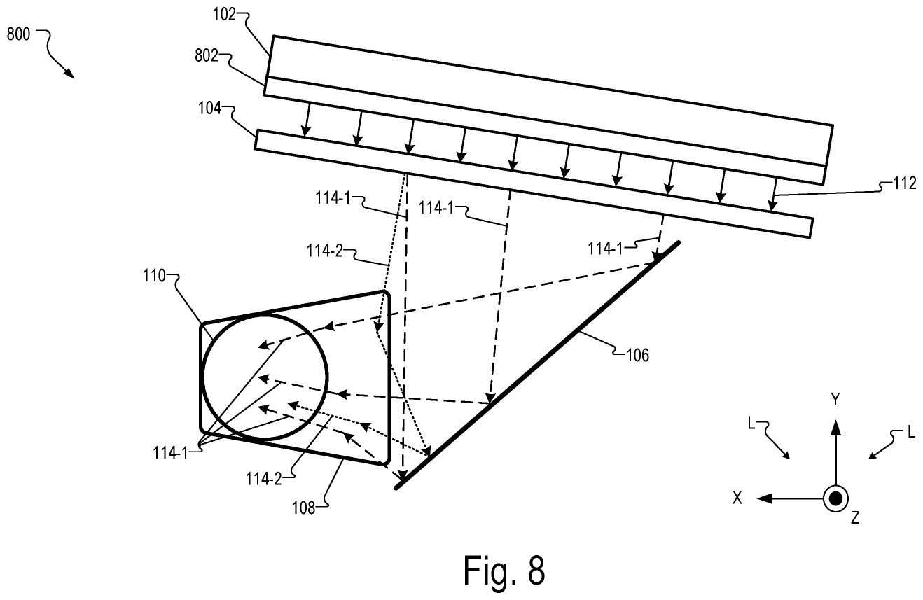

FIG. 8 shows another illustrative display system 800 having a folded optical path that mitigates the second image artifacts caused by third image light 114-3, the third image artifacts caused by fourth image light 114-4, and/or fourth image artifacts caused by fifth image light 114-5. Display system 800 is similar to display system 100 of FIGS. 1 and 2 except that, in display system 800, a light control device 802 is positioned behind display panel 104. Light control device 802 is configured to control a distribution angle of image light 114 provided from display panel 104. As compared with display system 100 of FIG. 1, display system 800 substantially mitigates or eliminates third image light 114-3 (e.g., image light having a wide distribution angle such that third image light 114-3 is incident directly on second reflector 108 without first being reflected by first reflector 106 (see FIG. 1)), fourth image light 114-4 (e.g., image light incident directly on eyepiece 110), and fifth image light 114-5 (e.g., image light reflected from first reflector 106 directly to eyepiece 110). By eliminating third image light 114-3, fourth image light 114-4, and fifth image light 114-5, light control device 802 mitigates or eliminates the second, third, and fourth image artifacts.

Light control device 802 may be any suitable device or structure configured to control (e.g., limit, narrow, or restrict) the distribution angle of image light 114 provided by display panel 104. Examples of a suitable light control device include, without limitation, a light control film (sometimes referred to as a privacy film), an optical fiber faceplate (e.g., glass and/or polymer), a mesh plate, a recorded holographic element, a dual function backlight (e.g., a backlight that functions as both a light source and a light control device), a parallax barrier, and a lenticular lens having light-blocking apertures. In some examples, as will be described in more detail, a light control device includes a combination of a light control film and a lens (e.g., a Fresnel lens). Illustrative configurations of light control device 802, backlight 102, and display panel 104 will now be described.

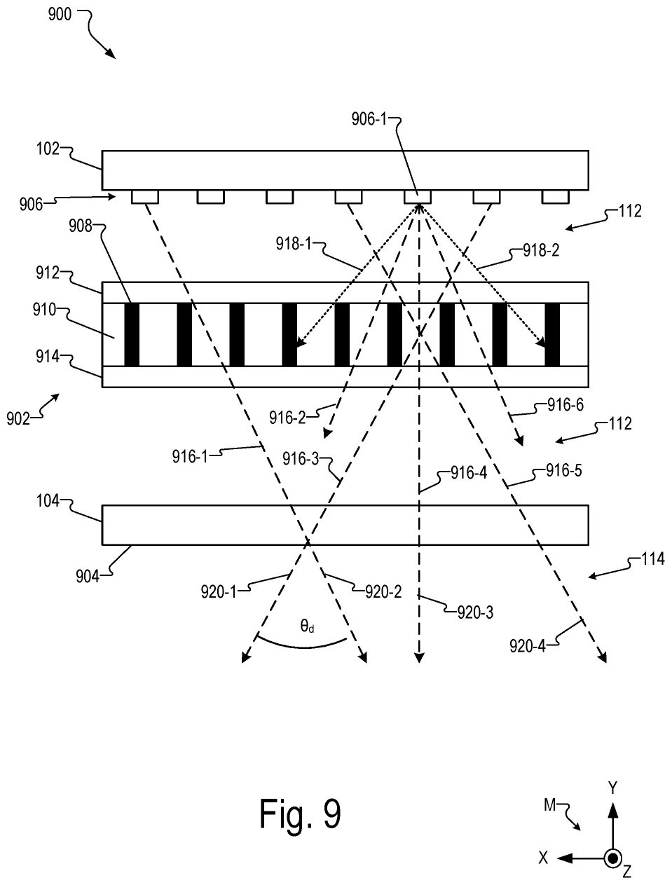

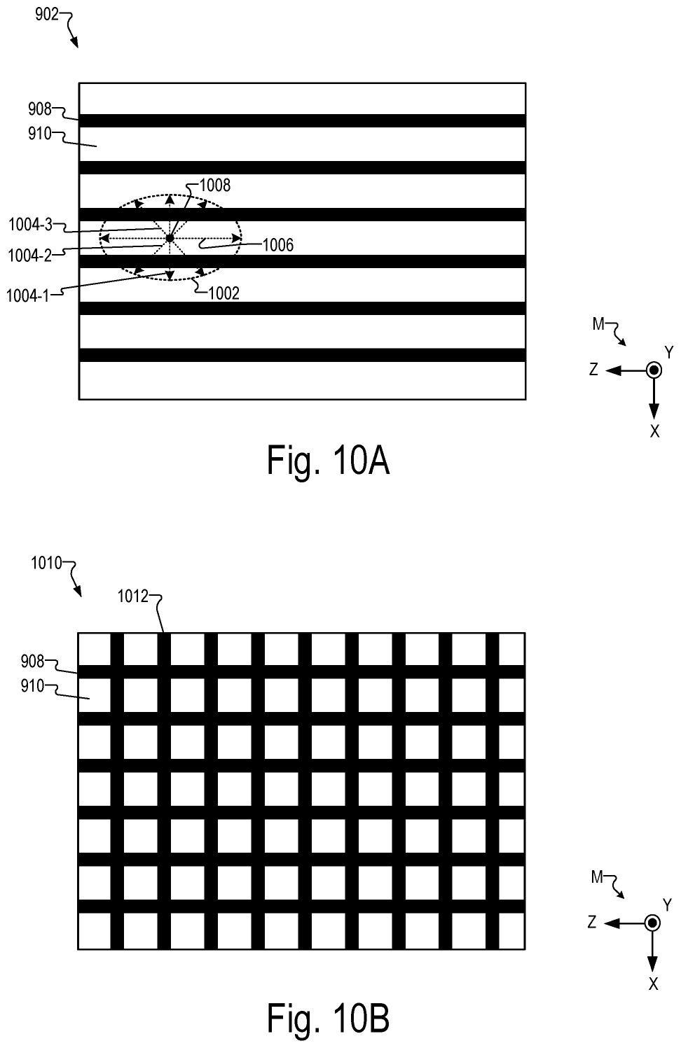

FIG. 9 shows an illustrative functional configuration 900 of backlight 102 and display panel 104 in operation with a light control film 902 that implements light control device 802. A legend M has been arbitrarily oriented so that a vector normal to a display surface 904 of display panel 104 extends in the −Y direction, a vertical direction of display panel 104 extends along the X-axis, and a horizontal direction of display panel 104 extends along the Z-axis. FIG. 9 shows a view of configuration 900 from the +Z direction. FIG. 10A shows a view of light control film 902 as viewed from the +Y direction.

As shown in FIG. 9, backlight 102 includes light sources 906, such as LEDs, that emit source light 112 toward light control film 902. As mentioned above, backlight 102 may also include other components (not shown) as may suit a particular implementation, such as a diffuser (e.g., a light guide plate, a reflector, etc.), a polarizing filter, a reflective polarizer, and/or a switching filter. The various components of backlight 102 may be layered in a backlight stack.

Light control film 902 is positioned behind (+Y direction) display panel 104 (e.g., on a light upstream side of display panel 104). As shown in FIGS. 9 and 10A, light control film 902 includes a set of opaque louvers 908 each extending along a first direction (e.g., along the Z direction) and a transparent bulk material 910 between louvers 908. A transparent upper film 912 (not shown in FIG. 10A) and a transparent lower film 914 (not shown in FIG. 10A) cover louvers 908 and bulk material 910 and hold the structure together. It will be recognized that light control film 902 is not limited to the configuration shown in FIGS. 9 and 10A and may have any other suitable configuration as may suit a particular implementation (e.g., louvers 908 may be inclined relative to the Y-axis direction and/or the Z-axis).

Generally, non-collimated light from a light source has a cone-shaped distribution spread. For example, as shown in FIG. 9 a distribution cone of source light 112 emitted by light source 906-1 includes source light rays 916-2, 916-4, and 916-6 and source light rays 918-1 and 918-2. Similarly, a distribution cone of image light 114 emitted from display panel 104 includes image light rays 920-1 and 920-2. A light distribution plane is an imaginary plane defined by two opposite rays of source light 112 or image light 114 and an optical axis of the distribution cone of source light 112 or image light 114. For example, as shown in FIG. 9 source light rays 916-3 and 916-5 and an optical axis (e.g., at source light ray 916-4) of source light rays 916-3 and 916-5 define a light distribution plane that is parallel to the X-Y plane. Similarly, image light rays 920-1 and 920-2 and an optical axis (not shown) of image light rays 920-1 and 920-2 define a light distribution plane that is parallel to the X-Y plane.

Portions of source light 112 having a relatively narrow emission angle (e.g., source light rays 916) are transmitted through light control film 902 (e.g., through transparent bulk material 910) toward display panel 104 while other portions of source light 112 (e.g., source light rays 918) having a relatively wide emission angle are blocked (e.g., absorbed) by louvers 908. The emission angle of source light 112 is the angle between source light 112 and a vector normal to an emission surface of backlight 102.

Display panel 104 modulates the source light 112 transmitted through light control film 902 to provide image light 114, which has a distribution spread that is controlled (e.g., limited or narrowed) by light control film 902 (e.g., by louvers 908) in one or more light control planes. As used herein, a light control plane is a light distribution plane in which the distribution of image light 114 (or source light 112) is controlled (e.g., limited, narrowed, or restricted) by light control film 902. Thus, a distribution angle of image light 114 (or of source light 112) in a light control plane is smaller than a distribution angle of image light 114 (or of source light 112) in a light distribution plane that is not a light control plane. As used herein, the distribution angle θ_{d} of image light 114 (or of source light 112) is the maximum possible angle between two rays of image light 114 (or of source light 112) that lie in a same light distribution plane. Since light control film 902 reduces the distribution angle of source light 112 in one or more light control planes, the distribution angle θ_{d} of image light 114 is controlled in one or more light control planes by the configuration of light control film 902, such as by the size, spacing, and/or orientation of louvers 908 and/or the thickness of light control film 902.

FIG. 10A shows an illustrative distribution profile 1002 of source light 112 transmitted through light control film 902, as projected onto an imaginary surface lying parallel to the X-Z plane. Distribution profile 1002 is represented by a dashed-line oval and includes an infinite number of light distribution planes perpendicular to the X-Y plane and passing through an optical axis 1008, including light control planes indicated by dashed lines 1004-1, 1004-2, and 1004-3 and a non-light control light distribution plane 1006. The light control plane represented by dashed line 1004-1 is perpendicular to louvers 908 (e.g., parallel to the X-Y plane) while non-light control light distribution plane 1006 is parallel to louvers 908 (e.g., parallel to the Y-Z plane). It will be recognized that light control film 902 includes other light distribution planes not represented in FIG. 10A. A primary light control plane is the light control plane having the minimum distribution angle θ_{d} of image light 114 (or of source light 112) among all light control planes. In the example of FIG. 10A, the light control plane represented by dashed line 1004-1 is the primary light control plane since the distribution angle θ_{d} of image light 114 is smallest in light control plane 1004-1 (see FIG. 9).

In some examples, light control film 902 is configured to control the distribution angle θ_{d} of image light 114 in one or more light control planes to be about 25° or less. In further examples, light control film 902 is configured to control the distribution angle θ_{d} of image light 114 in one or more light control planes to be about 20° or less. In even further examples, light control film 902 is configured to control the distribution angle θ_{d} of image light 114 in one or more light control planes to be about 15° or less. In yet further examples, light control film 902 is configured to control the distribution angle θ_{d} of image light 114 in one or more light control planes to be about 10° or less.

As shown in FIG. 9, light control film 902 is spaced apart from display panel 104 so as to avoid or mitigate moiré patterns since both light control film 902 and display panel 104 have alternating light-transmissive structures (e.g., bulk material 910 in light control film 902 and light-transmissive pixels in display panel 104) and light-blocking structures (e.g., louvers 908 in light control film 902 and structures between pixels in display panel 104). A gas (e.g., air, an inert gas, etc.) or a transparent material (not shown) may fill the gap between light control film 902 and display panel 104. In additional or alternative examples, moiré patterns are mitigated or eliminated by adjusting the spacing of louvers 908 (e.g., to be larger than a pixel pitch of display panel 104) and/or by tilting light control film 902 relative to display panel 104 (e.g., relative rotation about the Y-axis). For example, light control film 902 may be inclined relative to display panel 104 at a bias angle of approximately 8° or any other suitable angle.

As shown in FIG. 9, light control film 902 is also spaced apart from backlight 102, such as by a gas or a transparent material. The distance between backlight 102 and light control film 902 may affect to some extent the distribution angle θ_{d} of image light 114 and may reduce moiré patterns that may be formed by the periodic structure of backlight 102 and light control film 902.

In some configurations, backlight 102 may include a diffuser to mitigate or eliminate moiré patterns. However, a diffuser may reduce or eliminate the benefit of the narrow distribution angle obtained by light control film 902. By spacing light control film 902 away from backlight 102 and/or display panel 104, a diffuser may be omitted from backlight 102, thereby preserving the function and benefit of the narrow distribution angle obtained by light control film 902.

Backlight 102, light control film 902, and display panel 104 may be arranged together in any combination of layered structures and/or independent structures. For example, light control film 902 may be integrated into a layered structure of backlight 102. Alternatively, light control film 902 may be integrated into a layered structure of display panel 104. In other examples, backlight 102, light control film 902, and display panel 104 may be integrated into a single layered structure. In some examples, light control film 902 is separate from backlight 102 and/or display panel 104 (e.g., manufactured and installed in display system 800 independently of backlight 102 and/or display panel 104).

In the examples described above, light control film 902 controls the distribution of image light 114 in primary light control planes extending substantially along a single axis (e.g., along the X-axis). In other examples, light control device 802 is implemented by a light control film that controls the distribution of image light 114 in primary light control planes extending along multiple axes. FIG. 10B shows a configuration of an illustrative light control film 1010 that controls the distribution of image light 114 in multiple primary light control planes. Light control film 1010 is similar to light control film 902 except that light control film 1010 includes an additional set of louvers 1012 that extend along a second direction (e.g., along the Z-axis). Alternatively, light control film 1010 is formed by layering two light control films 902, rotated 90° (or any other suitable angle) relative to one another. Thus, light control film 1010 controls the distribution angle θ_{d} of image light 114 in primary light control planes extending along the X-axis and in primary light control planes extending along the Z-axis.

As another example, a light control film may be formed by layering three or more louvered light control films (e.g., light control film 902 and/or light control film 1010) in a stack, with each layer rotated relative to the other layers. For example, a light control film may be formed by layering three light control films 902, each rotated 60° relative to one another, to thereby form hexagonal openings through which image light 114 may pass. In this configuration, the light control film would have three primary light control planes.

Alternatively to a stack of louvered film layers, light control device 802 may be implemented by a mesh film, such as a hexagonal mesh formed of a blackened or light-absorbing metal or polymer material. The spaces within the mesh may be filled with air, an inert gas, or a transparent material.

As another example, light control device 802 may be implemented by a perforated plate. A perforated plate is a solid plate with holes formed therein to permit transmission of image light 114. The holes may have any suitable shape and configuration, such as round, square, hexagonal, octagonal, etc. The holes may be filled with air, an inert gas, or a transparent material.

In further examples, light control device 802 is implemented by a black clad optical fiber faceplate. An optical fiber faceplate is generally formed by bundling optical fibers together to form a block and then slicing the bundle to form individual faceplates, which may also be polished. The optical fibers may be formed of glass or a transparent polymer. The optical fibers are clad with a black, light-absorbing material (e.g., black glass, a black polymer, etc.). The black cladding absorbs image light 114 having a wide emission angle while image light 114 having a narrow emission angle passes through the optical fiber. As a result, the black-clad optical fiber faceplate has numerous primary light control planes. In some examples, the optical fibers and the black cladding are formed of a same or similar material (e.g., glass/black glass or a polymer/blackened polymer) having substantially the same index of refraction, thus preventing or minimizing reflection at the interface and allowing absorption of image light 114 even at high angles of incidence.

In some examples, light control device 802 is implemented by a polarization light control device that controls the distribution angle of image light 114 based on a polarization state of light produced by backlight 102. For example, the polarization light control device may include a polarization rotator positioned on a light input side and a polarizing filter on a light output side. The polarization rotator and the polarizing filter may be layered together in a stack or may be separate from one another with a gap or intermediate layer positioned therebetween. A polarization light control device may include any other number and type of polarization plates and optical components as may suit a particular implementation.

The polarization rotator is configured to rotate, in one or more stages, the polarization orientation of light from backlight 102 based on the incident angle of the light on the polarization rotator. The polarization rotator is configured to rotate incident light rays having a wide angle of incidence (e.g., wider than a threshold emission angle, such as 10°, 15°, 20°, etc.) to a first polarization orientation and rotate incident light rays having a narrow angle of incidence to a second polarization orientation. The polarization rotator may be implemented by any suitable device or optical film configured to rotate a polarization direction of linearly polarized light, such as a Faraday rotator, a birefringent rotator (e.g., a half-wave plate, a quarter-wave plate, a switchable wave plate, etc.), an absorptive linear polarizer oriented with an appropriate pass-axis direction, or a prism rotator.

The polarizing filter receives the light from the polarization rotator and selectively absorbs the light having the first polarization orientation while transmitting the light having the second polarization orientation. Any suitable polarizing filter may be used. The transmitted light having the second polarization orientation is output as source light 112, which is used to illuminate display panel 104. The output source light 112 has the second polarization orientation and therefore has a narrow distribution angle, while light from backlight 102 having a wide distribution angle has the first polarization orientation and is therefore absorbed by the polarizing filter.

In further examples, light control device 802 may be implemented by any other type of angular control mechanism as may suit a particular implementation, such as a parallax barrier or a lenticular lens (e.g., an array of lenses) having light-blocking apertures to block light rays having a wide distribution angle.

In the examples described above, light control device 802 is positioned behind display panel 104. In additional or alternative examples, light control device 802 and/or an additional light control device may be positioned downstream of display panel 104 at any suitable location, such as between display panel 104 and first reflector 106, between first reflector 106 and second reflector 108, and/or between second reflector 108 and eyepiece 110 (or an observation point).

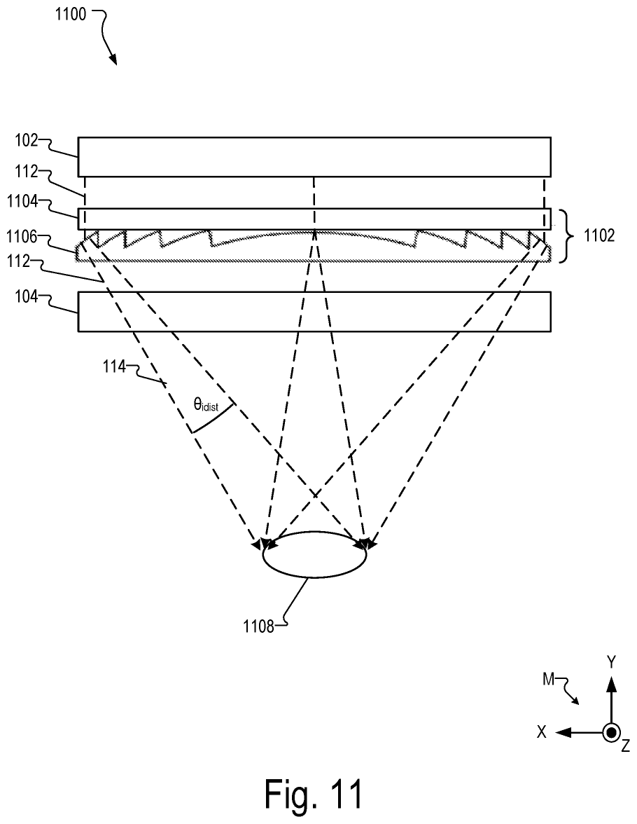

FIG. 11 shows another illustrative functional configuration 1100 of backlight 102 and display panel 104 in operation with a light control device 1102 that implements light control device 802. Backlight 102 and display panel 104 may be implemented in any suitable way, including in any way described herein. Configuration 1100 may include any additional or alternative components not shown, such as one or more optical components (e.g., lenses, filters, mirrors, light guides, diffractive elements, attenuators, etc.), support members (e.g., one or more support frames to support backlight 102, light control device 1102, and display panel 104), and the like.

Light control device 1102 is positioned behind (+Y direction) display panel 104 (e.g., on a light upstream side of display panel 104). Light control device 1102 includes both a light control film 1104 and a Fresnel lens 1106 positioned in front (−Y direction) of light control film 1104 (e.g., in a light downstream side of light control film 1104). Light control film 1104 may be any suitable light control film configured to control a distribution angle of image light 114 from display panel 104. In some examples, light control film 1104 is similar to or implemented by light control film 902.

Portions of source light 112 from backlight 102 having a relatively narrow emission angle are transmitted through light control film 1104 to Fresnel lens 1106 while other portions of source light 112 from backlight 102 having a relatively wide emission angle are blocked by light control film 1104. Fresnel lens 1106 faces away from display panel 104 and toward backlight 102 to redirect the source light 112 transmitted through light control film 1104 in a desired direction. Display panel 104 modulates the redirected source light 112 transmitted through light control device 1102 to provide image light 114.

As shown in FIG. 11, Fresnel lens 1106 has a focal length such that image light 114 is focused at an aperture 1108 in space. In some examples of a display system having a folded optical path (e.g., display system 800), aperture 1108 may be located on the surface of a reflector (e.g., first reflector 106). In alternative examples of a display system having a folded optical path, aperture 1108 may be located beyond the surface of a reflector. For instance, aperture 1108 may be located at an observation point of an eye of a viewer, in front of or behind the observation point of the eye of the viewer, or at any other suitable location (e.g., on the viewer-side of eyepiece 110). Light control device 1102 may also be used in other applications and systems that do not fold an optical path. In such applications, aperture 1108 may be at an eyepiece, an observation point of an eye of a viewer, or any other suitable location.

Fresnel lens 1106 may have any configuration as may suit a particular implementation. In some examples, the gaps between Fresnel lens 1106 and light control film 1104 are filled with a gas (e.g., air) or a transparent material. One or more intermediate films may also be positioned between Fresnel lens 1106 and light control film 1104. Furthermore, moiré patterns may be mitigated or eliminated in any way described above with respect to configuration 900.

Backlight 102, light control device 1102, and display panel 104 may be arranged together in any combination of layered structures and/or independent structures. For example, light control device 1102 may be integrated into a layered structure of backlight 102. Alternatively, light control device 1102 may be integrated into a layered structure of display panel 104. In other examples, backlight 102, light control device 1102, and display panel 104 may be integrated into a single layered structure. In some examples, light control device 1102 is separate from backlight 102 and/or display panel 104 (e.g., manufactured and installed in display system 800 independently of backlight 102 and/or display panel 104).

In configuration 1100, light control device 1102 narrows the distribution angle θ_{d} of image light 114 and redirects the narrowly-distributed image light 114 in a desired direction. With this structure, an ultra-narrow light control film 1104 may be used to provide image light 114 with an ultra-narrow distribution angle θ_{d}. Without Fresnel lens 1106, a distribution angle θ_{d} of image light 114 that is too narrow would result in only a small portion of the image being sufficiently bright and visible, so that peripheral regions of the image (e.g., regions around the bright image spot) appear dark. However, when light control device 1102 includes Fresnel lens 1106, image light 114 from the entire area of display panel 104 is directed toward aperture 1108, so the entire image appears bright and is visible. The narrowly distributed image light 114 is efficiently redirected to a desired location, thus maintaining image brightness and contrast. In this way, light control device 1102 enables a narrower distribution angle θ_{d} of image light 114 than would otherwise be possible without Fresnel lens 1106. For example, distribution angle θ_{d} of image light 114 may be approximately 15° or less in some examples, approximately 10° or less in other examples, and approximately 5° or less in yet further examples.

As shown in FIG. 11, the curved surfaces of Fresnel lens 1106 face away from display panel 104 with a gap between Fresnel lens 1106 and display panel 104 to increase the optical path length. With this configuration, the ridges of Fresnel lens 1106 are not visible. Additionally, moiré patterns between the Fresnel lens ridges and display panel 104 and moiré patterns between the Fresnel lens ridges and light control device 1104 are not visible.

Various modifications may be made to configuration 1100. In some examples, Fresnel lens 1106 may be omitted and image light 114 may be redirected using any other suitable device or means. For example, a convex lens may achieve a similar effect to Fresnel lens 1106. In other modifications, light control film 1104 may be substituted with another light control device, such as a lenticular lens having light-blocking apertures or a parallax barrier.

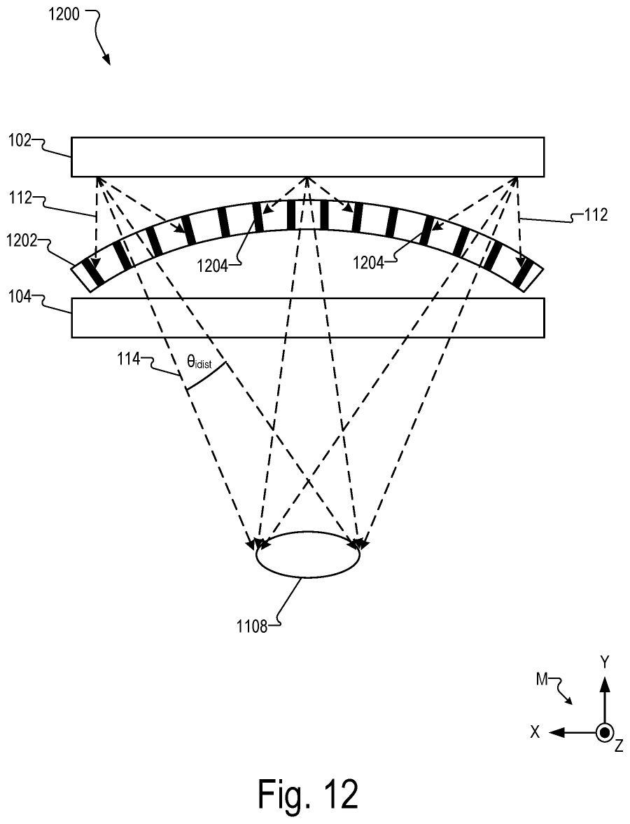

FIG. 12 shows another illustrative configuration 1200 of backlight 102 and display panel 104 in operation with a curved light control device 1202. Configuration 1200 is similar to configuration 1100 except that, in configuration 1200, light control film 1104 and Fresnel lens 1106 are replaced with curved light control device 1202. As shown, curved light control device 1202 is a light control film having a plurality of louvers 1204. Curved light control device includes a plurality of louvers 1204. The angles of louvers 1204 relative to backlight 102 increase with increasing distance from the center region of curved light control device 1202. However, curved light control device 1202 may be implemented by any other suitable light control device described above, including any light control film that controls the distribution of light in two or more primary light control planes

Since source light 112 emitted from backlight 102 has a generally diffuse distribution pattern with a wide emission angle, only those rays of source light 112 that are directed toward aperture 1108 pass through curved light control device 1202 and are emitted as image light 114. Other rays of source light 112 are absorbed or otherwise blocked by curved light control device 1202 (e.g., by louvers within curved light control device 1202).

Curved light control device 1202 may have any suitable curvature. In some examples, curved light control device 1202 is curved along two or more different axes. For example, curved light control device 1202 may have a dome shape, such as spherical, parabolic, etc. In other examples, curved light control device 1202 is curved along only a single axis. For example, curved light control device 1202 may have a cylindrical shape. Curved light control device 1202 may be formed in any suitable way, such as by forming a planar light control device (e.g., light control film 902) and then thermoforming the light control device to the desired shape. In some examples (not shown), backlight 102 is also curved, such as to substantially match the curvature of curved light control device 1202.

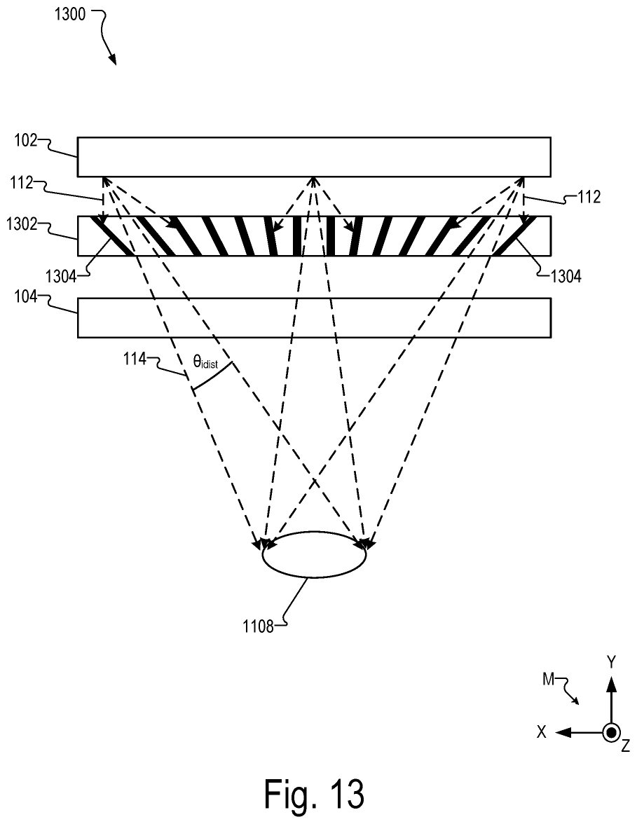

Alternatively to curved light control device 1202, a planar light control device that functions similarly to curved light control device 1202 may be used. FIG. 13 shows an illustrative configuration 1300 of backlight 102 and display panel 104 in operation with a planar light control device 1302 that functions similarly to a curved light control device. Configuration 1300 is similar to configuration 1200 except that, in configuration 1300, curved light control device 1202 is replaced with planar light control device 1302. As shown, planar light control device 1302 is a light control film having a plurality of louvers 1304. The outer angles of louvers 1304 relative to the source-side surface of planar light control device increase with increasing distance from the center region of planar light control device 1302. However, planar light control device 1302 may be implemented by any other suitable light control device described above, including any light control film that controls the distribution of light in two or more primary light control planes (e.g., a mesh film, a black clad optical fiber faceplate, etc.).

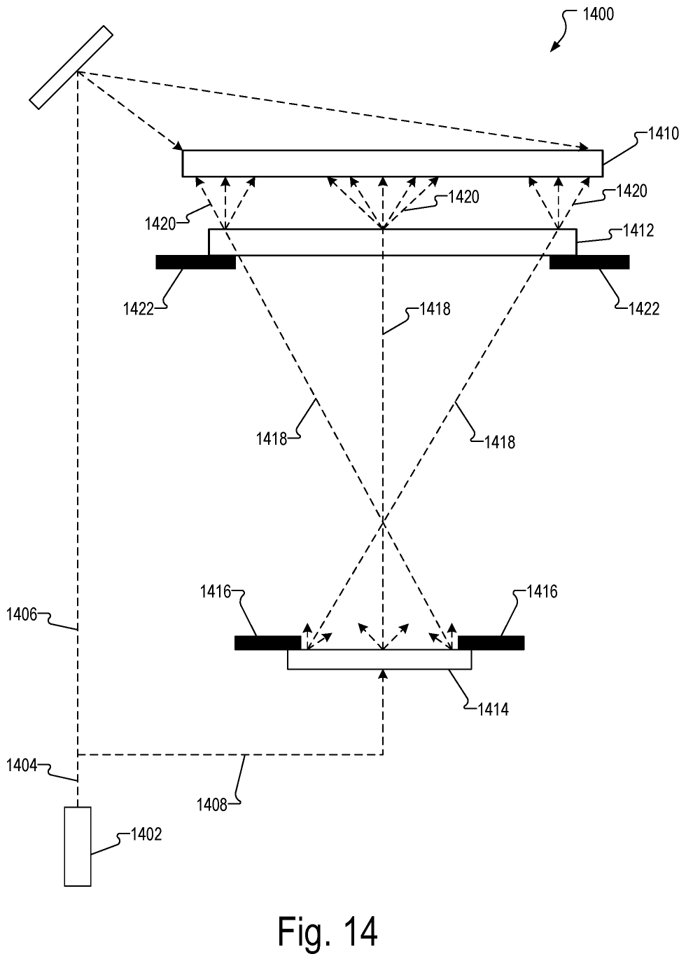

As mentioned above, light control device 802 may be implemented by a recorded holographic element that, when illuminated with a backlight, produces light having a desired distribution pattern (e.g., without stray light). FIG. 14 shows an illustrative configuration of a recording stage 1400 for recording a holographic element to be used as a light control device. Generally, a desired distribution of image light 114 is created in reverse to record the holographic element. As shown, a light source 1402 emits a collimated light beam 1404 that is split (e.g., by a beamsplitter) into a reference beam 1406 and an object beam 1408.

Reference beam 1406 is directed (e.g., by optics, mirrors, reflectors, waveguides, etc.) to and incident on a holographic element 1410 positioned behind (e.g., on a light upstream or light source side) of a display panel 1412. Holographic element 1410 may be implemented by any suitable holographic recording medium, such as but not limited to silver halide, photoresist, dichromated gelatin, photorefractive polymers, photochromic polymers, thermoplastic polymers, and photopolymers. Display panel 1412 may be implemented by any suitable display panel described herein, such as a liquid crystal display panel.

Object beam 1408 is directed to a diffuser 1414 positioned in front (e.g., on a light downstream or light emission side) of display panel 1412. Diffuser 1414 may be any suitable device configured to broadly diffuse light, such as a Lambertian diffuser, a holographic diffuser, a ground glass plate, a white glass plate, or a moving diffuser (which may be moved continuously during recording or just moved discretely to multiple positions during recording). In some examples in which holographic element 1410 is to be used in a display system having a folded optical path (e.g., display system 800), diffuser 1414 may be located at a position (e.g., a distance from display panel 1412) corresponding to the position of a reflector (e.g., first reflector 106) from the display panel 1412. In alternative examples of a display system having a folded optical path, diffuser 1414 may be located beyond the surface of a reflector. For instance, diffuser 1414 may be located at an observation point of an eye of a viewer, in front of or behind the observation point of the eye of the viewer, or at any other suitable location (e.g., on the viewer-side of eyepiece 110). Holographic element 1410 may also be used in other applications and systems that do not fold an optical path. In such applications, diffuser 1414 may be located at a position corresponding to the location of an eyepiece relative to the display panel 1412, an observation point of an eye of a viewer, or any other suitable location.

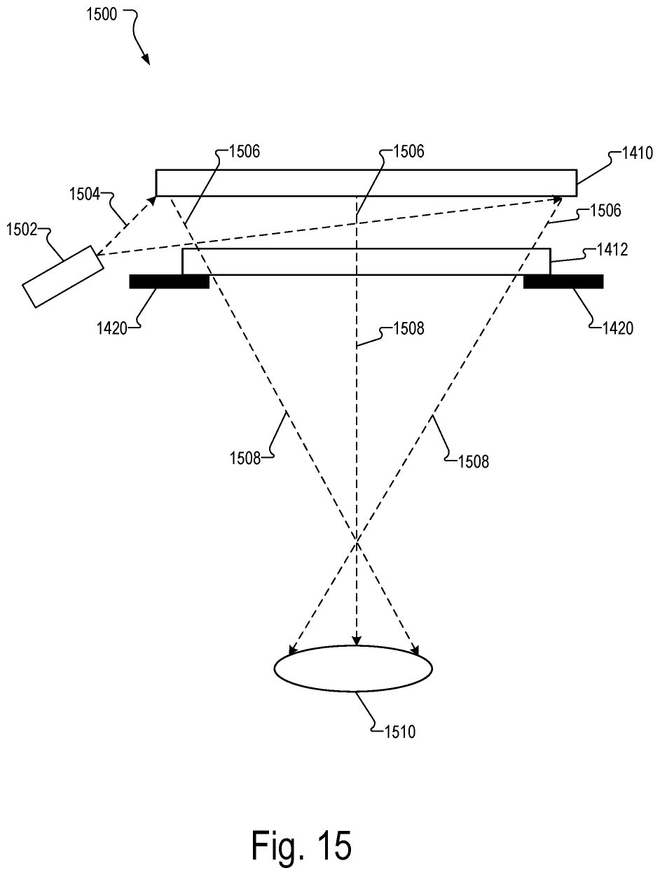

Object beam 1408 is incident on diffuser 1414, which diffuses object beam to emit diffuse light 1418 toward the light-emission side (diffuser 1414 side) of display panel 1412. Baffles 1416 may be positioned on either side of (or around) diffuser 1414 to restrict the spatial extent of diffuse light 1418 from diffuser 1414 at the edges of diffuser 1414. In effect, baffles 1416 determine the size (spatial extent) of an aperture to which image light will be directed during playback, as explained below in more detail with regard to FIG. 15.

Ordinarily, when light passes through a display panel, the display panel diffracts the light and creates a wide distribution of rays for every point on the panel. To control the distribution angle of image light 114 that is emitted from display panel 1412 when display panel 1412 is used in a display system, holographic element 1410 is recorded in the presence of display panel 1412. To this end, the cells of display panel 1412 are opened (e.g., the pixels are set to white) to allow diffuse light 1418 incident on display panel 1412 to pass through and be diffracted by display panel 1412 and fall on holographic element 1410. Diffracted diffuse light 1420 from the light source side (holographic element 1410 side) of display panel 1412 and reference beam 1406 interfere at holographic element 1410, thus creating an interference pattern that is recorded on holographic element 1410. Since the desired distribution of image light emitted from display panel 1412 is generated in reverse (e.g., object beam 1408 is incident on the light emission side of display panel 1412), the recorded light (diffracted diffuse light 1420) is not diffracted at the light emission side of display panel 1412. Baffles 1422 may be positioned on either side (or around) display panel 1412 to block diffuse light 1418 that would be incident on or bypass outside edges of display panel 1412.

FIG. 15 shows an illustrative configuration of a playback stage 1500 of holographic element 1410. In playback stage 1500, holographic element 1410 and display panel 1412 may be incorporated in a display system, such as a display system having a folded optical path (e.g., display system 800) or a display system that does not have a folded optical path (e.g., an open display system). In playback stage 1500, holographic element 1410 and display panel 1412 maintain the same positional relationship relative to one another as during recording stage 1400. For example, holographic element 1410 and display panel 1412 may be fixed together, such as by a mount, support frame, plate, adhesive, or other configuration.

A light source 1502 emits source light 1504 to illuminate holographic element 1410. As shown, source light 1504 illuminates the light emission side (display panel 1412 side) of holographic element 1410, which reflects and propagates a wavefront of source light 1506 toward display panel 1412. The wavefront of source light 1506 has encoded in it the interactions with display panel 1412 that were recorded during recording stage 1400. Accordingly, image light 1508 emitted from display panel 1412 is diffracted by display panel 1412 to produce image light 1508 without producing stray image light (such as second image light 114-2, third image light 114-3, fourth image light 114-4, and/or fifth image light 114-5). Thus, display panel 1412 diffracts source light 1506 in the manner that produces only the desired distribution of image light 1508 and no other light. Thus, image light 1508 emitted from display panel 1412 is directed only to an aperture 1510.

Aperture 1510 is a location corresponding to the position of diffuser 1414 during recording stage 1400. Aperture 1510 may be the position of a reflector (e.g., first reflector 106) of a display system having a folded optical path, a position located beyond the surface of a reflector of a folded optical path (e.g., an observation point of an eye of a viewer, in front of or behind the observation point of the eye of the viewer), the location of an eyepiece relative to the display panel 1412, an observation point of an eye of a viewer, or any other suitable location.

Using recorded holographic element 1410 as a light control device, as just described, overcomes diffraction caused by display panel 1412 so that image light 1508 emitted from display panel 1412 has the desired distribution pattern and does not include stray light. Holographic element 1410 may be incorporated into any desired display system where playback stage 1500 may occur. In some examples, holographic element 1410 is incorporated into a display system of a computer-assisted surgical system, as described further below.

On the other hand, recording stage 1400 may be performed in a different system than playback stage 1500, particularly given the differing configurations of light source 1402 and light source 1502. In some examples, recording stage 1400 is performed in a recording fixture configured specifically for recording holographic element 1410 for later use in the optical system. The recording fixture may include light source 1402, diffuser 1414, and fixtures (e.g., frames, mounts, supports, etc.) for receiving and holding holographic element 1410 and display panel 1412 in a fixed configuration relative to light source 1402 and diffuser 1414. The recording fixture may also include baffles 1416 and/or baffles 1422. After recording, holographic element 1410 and display panel 1412 may be removed from the recording fixture and placed in a display system for playback stage 1500. Alternatively, holographic element 1410 may be removed from the recording fixture and placed in a display system having another display panel.

While FIGS. 14 and 15 show that holographic element 1410 and display panel 1412 are separated from one another, holographic element 1410 and display panel 1412 may be fixed to one another, such as by a frame, support, mount, or other connecting structure. Alternatively, holographic element 1410 and display panel 1412 may be layered together in a display stack, with or without one or more intervening layers.

In some examples, a display system includes both recorded holographic element 1410 and any of the other light control devices and/or light control mechanisms described herein (e.g., silicon mirror configured at the Brewster's angle), which may be used to further restrict and/or redirect any other stray image light that might be generated. Alternatively, holographic element 1410 may be the only light control device used in the display system. Moreover, due to the tight control of the distribution of emitted image light 1508 by recorded holographic element 1410, reflectors in a folded optical path may be formed of a highly reflective material (rather than less-reflective silicon) without regard to the Brewster angle configuration described above.

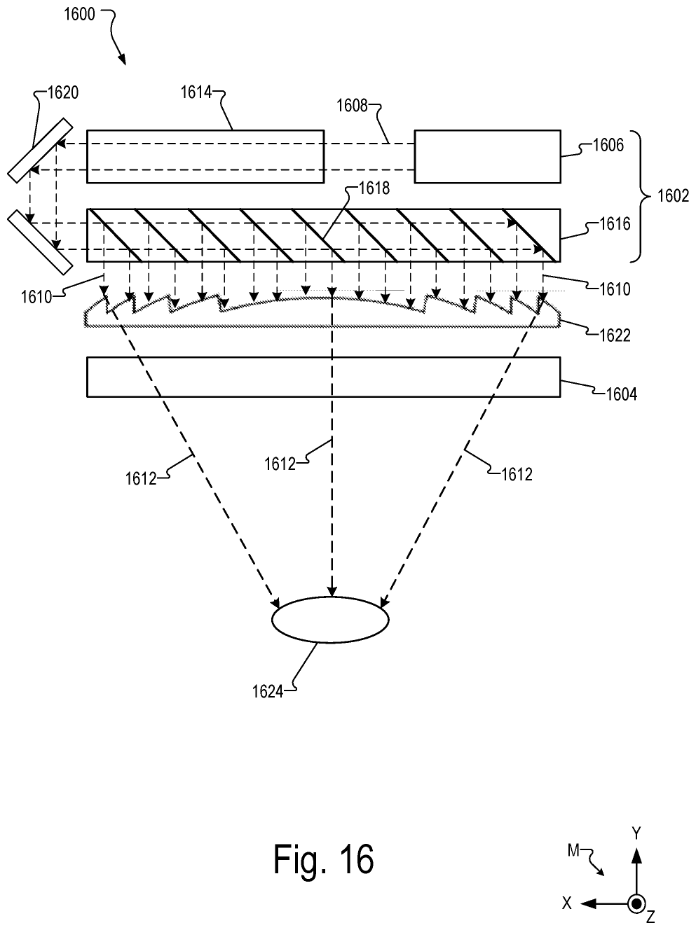

Illustrative examples of an integrated backlight/light control device that functions as both a light source and a light control device will now be described with reference to FIG. 16. FIG. 16 shows an illustrative configuration 1600 of an integrated backlight/light control device 1602 (“integrated backlight 1602”) that produces backlight for a display panel 1604. A legend M having an X axis, Y axis, and Z axis has been arbitrarily oriented so that a vector normal to a display surface of display panel 1604 extends in the −Y direction, a vertical direction of display panel 104 extends along the X-axis, and a horizontal direction of display panel 104 extends along the Z-axis. A light source 1606 emits a collimated source beam 1608 that is collimated in at least one dimension and expanded in at least one dimension (the same or different dimension(s)) to form a larger collimated source beam 1610 to illuminate substantially the entire light source side of display panel 1604. For example, source beam 1608 may be collimated along the Y axis and Z axis and then expanded along either or both of the Y axis and Z axis to produce collimated source beam 1610. Alternatively, source beam 1608 may be collimated along the Y axis, divergent along the Z axis, and then collimated and expanded along the Z axis (thereby achieving expansion along the Z axis) and/or expanded along the Y axis to produce collimated source beam 1610. Collimated source beam 1610 has an extremely narrow emission angle/distribution angle in one or more dimensions, so image light 1612 emitted by display panel 1604 also has an extremely narrow distribution angle in one or more dimensions, thus reducing or preventing stray image light.

Light source 1606 may be or may include any suitable device configured to produce collimated source beam 1608, such as a laser, a collimating lens, a parabolic mirror etc. Collimated source beam 1608 may then be expanded in any suitable way. As shown in FIG. 16, integrated backlight 1602 includes a first beam expander 1614 and a second beam expander 1616. First beam expander 1614 expands collimated source beam 1608 in a first dimension and second beam expander 1616 expands collimated source beam 1608 in a second dimension, thereby forming collimated source beam 1610. First beam expander 1614 and second beam expander 1616 may be implemented by any suitable beam expanding component(s) (e.g., lenses, optics, waveguides, etc.). For example, first beam expander 1614 may be a lens system that expands collimated source beam 1608 in one dimension. Second beam expander 1616 is shown as an array waveguide that expands the collimated source beam 1608 in another dimension through an array of transflective mirrors 1618 (e.g., partially reflective and partially transmissive mirrors).

As shown in FIG. 16, light source 1606, first beam expander 1614, and second beam expander 1616 are positioned along a folded optical path that includes mirrors 1620. Such configuration may facilitate implementation of integrated backlight 1602 in a display system having a compact architecture. However, integrated backlight 1602 may have any other configuration of a folded optical path, or may be configured in a straight (non-folded) optical path.

A Fresnel lens 1622 is positioned between integrated backlight 1602 and display panel 1604 to direct image light 1612 to a desired location 1624. In some examples, a diffuser (not shown) is positioned between second beam expander 1616 and Fresnel lens 1622 to produce some light divergence. Any suitable diffuser may be used, including any diffuser described herein. A gap may be located between the diffuser and display panel 1604 to lengthen the optical path and thus hide or mitigate any artifacts that might be produced from the diffuser (e.g., by using diffraction at display panel 1604 to hide or mitigate artifacts produced by the diffuser).

By using a collimated source beam 1610 as a backlight for display panel 1604, stray image light from display panel 1604 can be reduced or prevented. Integrated backlight 1602 is also highly efficient because substantially all light generated by light source 1606 is received by display panel 1604 (e.g., no light is blocked or absorbed by a light-blocking light control device). However, in other configurations integrated backlight 1602 is used in combination with any of the light control devices described herein to further restrict the distribution angle of any stray image light that might be generated.

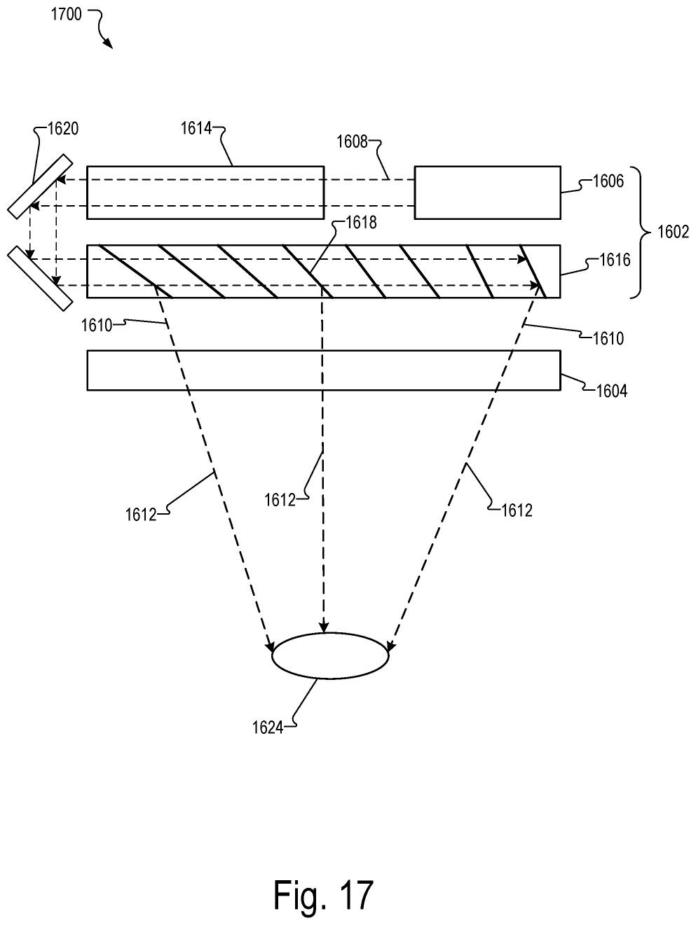

In an alternative configuration, Fresnel lens 1622 may be omitted and/or may be substituted with any other device or structure described herein to direct image light 1612 to a desired location. FIG. 17 shows another illustrative configuration 1700 using integrated backlight 1602. Configuration 1700 is similar to configuration 1600 except that, in configuration 1700, Fresnel lens 1622 is omitted and transflective mirrors 1618 of second beam expander 1616 are variably angled so that the angle of incidence of collimated source beam 1608 on transflective mirrors 1618 decreases with increasing distance from a light upstream side of display panel 1604. With this configuration, image light 1612 is directed to desired location 1624 without the use of a Fresnel lens.

In some examples, a display system may be configured to mitigate the first, second, third, and fourth image artifacts. For example, display system 300 may also include light control device 802 to control a distribution angle of image light 114 provided from display panel 104. Similarly, second reflector 108 of display system 800 may be positioned relative to second image light 114-2 and a polarization direction of second image light 114-2 incident on second reflector 108 may have a first orientation such that reflectance of a portion of second image light 114-2 from second reflector 108 is approximately zero, as described above. The display systems, optical structures, and light control devices described herein may be implemented as part of or in conjunction with a computer-assisted surgical system. As such, an exemplary computer-assisted surgical system will now be described. The following exemplary computer-assisted surgical system is illustrative and not limiting, as the display systems, optical structures, and light control devices described herein may be implemented as part of or in conjunction with other suitable systems.

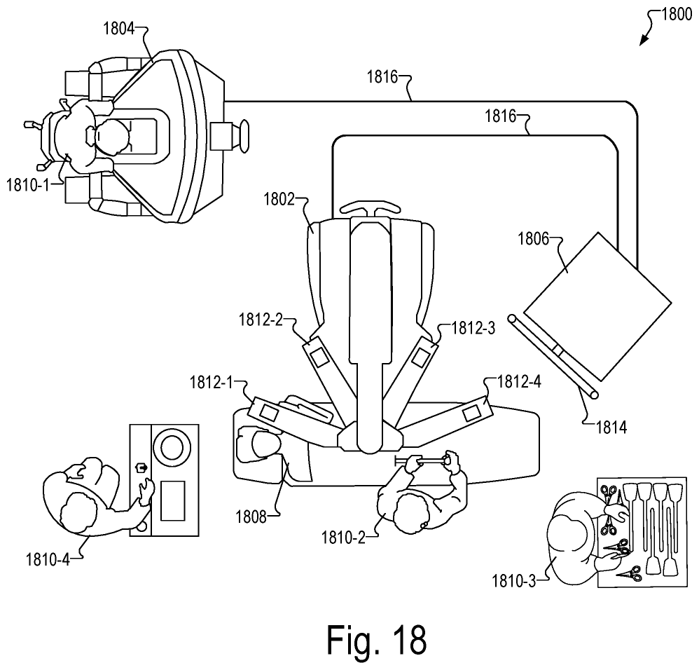

FIG. 18 illustrates an exemplary computer-assisted surgical system 1800 (“surgical system 1800”). As shown, surgical system 1800 may include a manipulating system 1802, a user control system 1804, and an auxiliary system 1806 communicatively coupled one to another. In some examples, surgical system 1800 may be implemented by one or more of these components. However, surgical system 1800 is not limited to these components, and may include additional components as may suit a particular implementation, such as but not limited to a subject operating table, third-party components (e.g., electrosurgical units) connected to surgical system 1800, and the like.

Surgical system 1800 may be utilized by a surgical team to perform a computer-assisted surgical procedure on a subject 1808. As shown, the surgical team may include a surgeon 1810-1, an assistant 1810-2, a nurse 1810-3, and an anesthesiologist 1810-4, all of whom may be collectively referred to as “surgical team members 1810.” Additional or alternative surgical team members may be present during a surgical session as may serve a particular implementation.

While FIG. 18 illustrates an ongoing minimally invasive surgical procedure, surgical system 1800 may similarly be used to perform open surgical procedures or other types of surgical procedures that may similarly benefit from the accuracy and convenience of surgical system 1800. Additionally, it will be understood that the surgical session throughout which surgical system 1800 may be employed may not only include an intraoperative phase of a surgical procedure, as is illustrated in FIG. 18, but may also include preoperative, postoperative, and/or other suitable phases of the surgical procedure. A surgical procedure may include any procedure in which manual and/or instrumental techniques are used on a subject to investigate, diagnose, or treat a physical condition of the subject. Additionally, a surgical procedure may include any non-clinical procedure, e.g., a procedure that is not performed on a live subject, such as a calibration or testing procedure, a training procedure, and an experimental or research procedure.

As shown in FIG. 18, manipulating system 1802 may include a plurality of manipulator arms 1812 (e.g., manipulator arms 1812-1 through 1812-4) to which a plurality of surgical instruments (not shown in FIG. 18) may be coupled. Each surgical instrument may be implemented by any suitable surgical tool (e.g., a tool having tissue-interaction functions), medical tool, monitoring instrument (e.g., an endoscope), sensing instrument (e.g., a force-sensing surgical instrument), diagnostic instrument, or the like that may be used for a computer-assisted surgical procedure (e.g., by being at least partially inserted into subject 1808 and manipulated to perform a computer-assisted surgical procedure on subject 1808). While manipulating system 1802 is depicted and described herein as including four manipulator arms 1812, it will be recognized that manipulating system 1802 may include only a single manipulator arm 1812 or any other number of manipulator arms as may serve a particular implementation.

Surgical instruments attached to manipulator arms 1812 may each be positioned at a surgical area associated with a subject. A “surgical area” may, in certain examples, be entirely disposed within a subject and may include an area within the subject at or near where a surgical procedure is planned to be performed, is being performed, or has been performed. For example, for a minimally invasive surgical procedure being performed on tissue internal to a subject, the surgical area may include the tissue, anatomy underlying the tissue, as well as space around the tissue where, for example, surgical instruments being used to perform the surgical procedure are located. In other examples, a surgical area may be at least partially disposed external to the subject at or near where a surgical procedure is planned to be performed, is being performed, or has been performed on the subject. For instance, surgical system 1800 may be used to perform an open surgical procedure such that part of the surgical area (e.g., tissue being operated on) is internal to the subject while another part of the surgical area (e.g., a space around the tissue where one or more surgical instruments may be disposed) is external to the subject. A surgical instrument may be referred to as being positioned or located at or within a surgical area when at least a portion of the surgical instrument (e.g., a distal portion of the surgical instrument) is located within the surgical area.

User control system 1804 may be configured to facilitate control by surgeon 1810-1 of surgical system 1800 (e.g., manipulator arms 1812 and surgical instruments attached to manipulator arms 1812). For example, surgeon 1810-1 may interact with user input devices included in user control system 1804 to remotely move or manipulate manipulator arms 1812 and the surgical instruments coupled to manipulator arms 1812. To this end, user control system 1804 may provide, by way of a display system (e.g., display system 300 or 800) surgeon 1810-1 with still or moving images (e.g., high-definition stereoscopic images) of a surgical area associated with subject 1808 as captured by an imaging device (e.g., a stereoscopic endoscope). Surgeon 1810-1 may utilize the images to perform one or more procedures with one or more surgical instruments coupled to manipulator arms 1812.

To facilitate control of surgical instruments, user control system 1804 may include a set of user input devices (not shown in FIG. 18). The user input devices may be manipulated by surgeon 1810-1 to control movement of surgical instruments (e.g., by utilizing robotic and/or teleoperation technology). The user input devices may be configured to detect a wide variety of hand, wrist, and finger movements by surgeon 1810-1. In this manner, surgeon 1810-1 may intuitively perform a surgical procedure using one or more surgical instruments.

Auxiliary system 1806 may include one or more computing devices configured to perform primary processing operations of surgical system 1800. The one or more computing devices included in auxiliary system 1806 may control and/or coordinate operations performed by various other components (e.g., manipulating system 1802 and/or user control system 1804) of surgical system 1800. For example, a computing device included in user control system 1804 may transmit instructions to manipulating system 1802 by way of the one or more computing devices included in auxiliary system 1806. As another example, auxiliary system 1806 may receive, from manipulating system 1802 (e.g., from an imaging device), and process image data representative of images captured by an endoscope attached to a manipulator arm 1812.

In some examples, auxiliary system 1806 may be configured to present, by way of a display system in auxiliary system 1806 (e.g., display system 300 or 800), visual content to surgical team members 1810 who may not have access to the images provided to surgeon 1810-1 at user control system 1804. To this end, auxiliary system 1806 may include a display monitor 1814 configured to display one or more user interfaces, such as images (e.g., 3D images) of the surgical area, information associated with subject 1808 and/or the surgical procedure, and/or any other visual content as may serve a particular implementation. For example, display monitor 1814 may display images of the surgical area together with additional content (e.g., graphical content, contextual information, etc.) concurrently displayed with the images. In some embodiments, display monitor 1814 is implemented by a touchscreen display with which surgical team members 1810 may interact (e.g., by way of touch gestures) to provide user input to surgical system 1800. Display monitor 1814 may implement display panel 104 or eyepiece 110 of display system 300 or 800. In some examples, display monitor 1814 may include a configuration of a backlight, light control device, and display panel similar to any of the configurations described herein to restrict a visible angle of images displayed on display monitor 1814.

While auxiliary system 1806 is shown in FIG. 18 as a separate system from manipulating system 1802 and user control system 1804, auxiliary system 1806 may be included in, or may be distributed across, manipulating system 1802 and/or user control system 1804. Additionally, while user control system 1804 has been described as including one or more user input devices and/or audio input devices, other components of surgical system 1800 (e.g., manipulating system 1802 and/or auxiliary system 1806) may include user input devices, audio input devices, and/or audio output devices as may suit a particular implementation.

Manipulating system 1802, user control system 1804, and auxiliary system 1806 may be communicatively coupled one to another in any suitable manner. For example, as shown in FIG. 18, manipulating system 1802, user control system 1804, and auxiliary system 1806 may be communicatively coupled by way of control lines 1816, which may represent any optical, wired, or wireless communication link as may serve a particular implementation. To this end, manipulating system 1802, user control system 1804, and auxiliary system 1806 may each include one or more optical, wired, or wireless communication interfaces, such as one or more local area network interfaces, Wi-Fi network interfaces, cellular interfaces, etc.

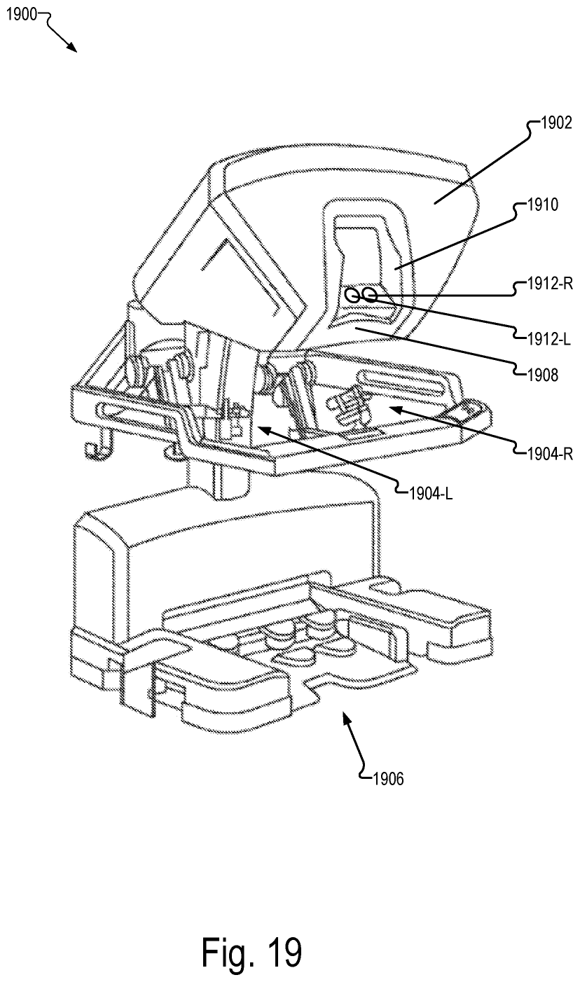

FIG. 19 shows an illustrative user control system 1900 with which a user (e.g., surgeon 1810-1) may interact to control various operations of a computer-assisted surgical system (e.g., surgical system 1800). In some examples, user control system 1900 implements user control system 1804.

As shown, user control system 1900 includes a display module 1902, a set of user input devices 1904 (e.g., a left user input device 1904-L and a right user input device 1904-R), and a set of foot pedals 1906. User control system 1900 may include additional or alternative components as may serve a particular implementation. For example, user control system 1900 may include various computing components (e.g., processors, memory, etc.), support structures (e.g., a base, a column, etc.), adjustment mechanisms (e.g., pivots, motors, etc.), user input devices, and the like.

Display module 1902 includes an image display system 1908 within a housing of display module, a viewer console 1910, and eyepieces 1912 (e.g., a left eyepiece 1912-L and a right eyepiece 1912-R). Image display system 1908 is configured to present images generated by surgical system 1800, such as images of a surgical area associated with a subject as captured by a stereoscopic endoscope. Images presented by image display system 1908 may be viewed through eyepieces 1912 when the user's head is positioned in viewer console 1910. Image display system 1908 may implemented, in whole or in part, by any display system described herein (e.g., display system 300 or 800), or any components thereof. In some examples, eyepieces 1912 may each be implemented by an eyepiece 110.

User input devices 1904 may include a variety of mechanisms (e.g., buttons, finger loops, levers, pivot points, etc.) configured to receive a wide variety of hand, wrist, and finger movements by a surgeon. Movements of user input devices 1904 may be translated into corresponding movements of a manipulator arm 1812 and/or a surgical instrument. Accordingly, the surgeon may manipulate user input devices 1904 in various ways and with multiple degrees of freedom in order to telemanipulate a manipulator arm 1812 and/or a surgical instrument coupled to a manipulator arm 1812 (e.g., by utilizing robotic and/or teleoperation technology).

In some examples, the optical paths of image display system 1908 are folded so that user input devices 1904 may be positioned in front of a user of user control system 1900 in a natural and comfortable position. By using the display systems, optical structures, and/or light control devices described herein, image artifacts that might otherwise be generated by image display system 1908 and observed through eyepieces 1912 may be mitigated or eliminated.

In some examples, a user control system or other display of a computer-assisted surgical system may be “open” such that a user views surgical images on an open display (e.g., a touchscreen display, a flat screen display, a monitor, etc.) rather than through a “closed” system (e.g., through eyepieces 1912). Any of the display systems, optical structures, and/or light control structures may be used in an open display system. For instance, light control device 1102 may be employed as a privacy film on an open display to restrict the visibility of displayed content to a particular position.

As mentioned, the display systems, optical structures, and/or light control devices described herein may be implemented as part of or in conjunction with other surgical systems and non-surgical systems. For example, light control device 1102 may be employed as a privacy film to provide a large display visible with uniform brightness from one eye position, but not visible from other eye positions. Conventional privacy films are limited in how well they can control the distribution of image light because distribution angles that are too narrow reduce brightness and may produce dark spots.

In some examples, light control device 1102 may be used as a privacy film in automotive and/or airplane displays to restrict the visibility of content to a particular seat position (e.g., a passenger seat, a driver seat, etc.). Additionally or alternatively, light control device 1102 may be used to restrict stray light from an automotive display hitting nearby surfaces (e.g., dashboard displays) while maintaining a desired brightness of the display.

In other examples, light control device 1102 may be used in “shared path” autostereoscopic 3D displays where content is presented to one eye but not to the other (e.g., when a user is looking at two optically coincident displays simultaneously, but each eye can only see one display).

In some examples, any of the display systems, optical structures, and/or light control structures may be used in a wearable device such as a head-mounted display, a virtual reality system, or an augmented reality system.

In the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A display system comprising:
a display panel;
a first reflector; and
a second reflector;
wherein:
the display panel provides first image light representative of a displayed image to the first reflector and provides second image light representative of at least a portion of the displayed image to the second reflector without first being reflected by the first reflector;
the first reflector reflects the first image light from the display panel toward the second reflector;
the second reflector reflects the first image light from the first reflector toward an eyepiece; and
the second reflector is positioned relative to the second image light and a polarization direction of the second image light incident on the second reflector has a first orientation such that reflectance of a portion of the second image light from the second reflector is approximately zero.

2. The display system of claim 1, wherein the second reflector is a silicon mirror.

3. The display system of claim 2, wherein the second reflector is positioned relative to the second image light such that an angle of incidence of the second image light on the second reflector ranges from about 63° to about 83°.

4. The display system of claim 2, wherein the second reflector is positioned relative to the second image light such that an angle of incidence of the second image light on the second reflector ranges from about 72° to about 80°.

5. The display system of claim 2, wherein the second reflector is positioned relative to the second image light such that an angle of incidence of the second image light on the second reflector ranges from about 75° to about 78°.

6. The display system of claim 2, wherein the second reflector is positioned relative to the first image light from the first reflector such that an angle of incidence of the first image light from the first reflector on the second reflector is greater than about 86°.

7. The display system of claim 2, wherein the second reflector is positioned relative to the first image light from the first reflector such that a minimum reflectance of the first image light reflected from the second reflector is greater than about 40%.

8. The display system of claim 1, wherein the second reflector is positioned relative to the second image light such that at least a portion of the second image light is incident on the second reflector at the Brewster angle of the second reflector.

9. The display system of claim 1, wherein the second reflector is positioned relative to the second image light such that a maximum reflectance of the second image light reflected from the second reflector is less than about 20%.

10. The display system of claim 1, wherein the second reflector is positioned relative to the second image light such that a maximum reflectance of the second image light reflected from the second reflector is less than about 10%.

11. The display system of claim 1, wherein the second image light provided by the display panel is linearly polarized.

12. The display system of claim 1, further comprising a polarizer that linearly polarizes the second image light provided by the display panel prior to the second image light reaching the second reflector.

13. The display system of claim 1, further comprising a polarization rotator that rotates the polarization direction of the second image light from a second orientation to the first orientation.

14. The display system of claim 1, wherein the display panel modulates source light emitted from a backlight to provide the first image light.

15. The display system of claim 14, further comprising a light control device positioned behind the display panel and configured to control a distribution angle of the first image light and the second image light provided by the display panel.

16. The display system of claim 14, further comprising the backlight.

17-42. (canceled)

43. A light control device comprising a holographic element having a recorded interference pattern produced by a reference beam and an object beam incident on a light emission side of a display panel and transmitted through the display panel.

44. A method of making a light control device, comprising:
recording, by a holographic element, an interference pattern produced by interference of:
a reference beam incident on the holographic element; and
an object beam incident on the holographic element after the object beam was incident on a light-emission side of a display panel and transmitted through the display panel.

45. The method of claim 44, further comprising:
diffusing, by a diffuser, the object beam prior to the object beam being incident on the display panel.

46. The method of claim 44, further comprising:
arranging the holographic element and the display panel in a display system comprising a backlight, wherein the holographic element is positioned, along an optical path of source light produced by the backlight, between the backlight and the display panel.
